(19) United States
(12) Patent Application Publication
(10) Pub. No.: US 2026/0265597 A1
(43) Pub. Date: Sep. 10, 2026

(54) AZEOTROPE AND AZEOTROPE-LIKE COMPOSITIONS OF 1,1-DIFLUOROPROPENE (HFO-1252ZC) AND OTHER COMPOUNDS, AND APPLICATIONS THEREOF

(71) Applicant: Solstice Advanced Materials US, Inc., Morris Plains, NJ (US)

(72) Inventors: Joshua Close, Cheektowaga, NY (US); Pramod K.W. Harikumar Warrier, Cheektowaga, NY (US); Ryan J. Hulse, Getzville, NY (US); Kaimi Gao, Charlotte, NC (US); Justin Howard, Lakeview, NY (US)

(21) Appl. No.: 19/555,813

(22) Filed: Mar. 3, 2026

Related U.S. Application Data
(60) Provisional application No. 63/767,208, filed on Mar. 5, 2025.

(51) Int. Cl. C09K 5/04; F25B 31/00; F25B 41/31

(52) U.S. Cl. CPC C09K 5/045; F25B 31/00; F25B 41/31

(57) ABSTRACT

An azeotrope or azeotrope-like composition consisting essentially of effective amounts of 1,1-difluoropropene (HFO-1252zc) and other compounds, including each of difluoromethane (HFC-32), 1,1,1,2-tetrafluoroethane (HFC-134a), 1,1-difluoroethane (HFC-152a), and 2,3,3,3-tetrafluoropropene (HFO-1234yf), and applications or uses for these compositions.

### CROSS-REFERENCE TO RELATED APPLICATIONS

This application claims priority to U.S. Provisional Application No. 63/767,208, filed Mar. 5, 2025, which is herein incorporated by reference in its entirety.

### FIELD

The present disclosure relates to azeotrope and azeotrope-like compositions and, in particular, to azeotrope and azeotrope-like compositions consisting essentially of 1,1-difluoropropene (HFO-1252zc) and other compounds, including each of difluoromethane (HFC-32), 1,1,1,2-tetrafluoroethane (HFC-134a), 1,1-difluoroethane (HFC-152a), and 2,3,3,3-tetrafluoropropene (HFO-1234yf), and applications or uses for these compositions.

### BACKGROUND

Fluorocarbon fluids have properties that are desirable for use as heat transfer media, immersion coolants, liquid or gaseous dielectrics, industrial refrigerants, and other applications.

For example, 1,1-difluoropropene (HFO-1252zc) has recently found increased utility for a variety of uses. Potential end use applications of HFO-1252zc include refrigerants, either used alone or in blends with other components, solvents for organic materials, and as a chemical intermediate in the synthesis of other halogenated hydrocarbon solvents.

As azeotropes and azeotrope-like compositions are not predictable, there is an ongoing needed to discover and develop new and useful azeotropes and azeotrope-like compositions.

There is also an ongoing need to discover and develop new and useful applications for azeotropes and azeotrope-like compositions.

### SUMMARY

The present disclosure provides minimum-boiling, homogenous azeotrope or azeotrope-like compositions consisting essentially of 1,1-difluoropropene (HFO-1252zc) and other compounds, including each of difluoromethane (HFC-32), 1,1,1,2-tetrafluoroethane (HFC-134a), and 1,1-difluoroethane (HFC-152a), 2,3,3,3-tetrafluoropropene (HFO-1234yf), and applications or uses for these compositions.

In one form thereof, the present disclosure provides an azeotrope or azeotrope-like composition consisting essentially of effective amounts of 1,1-difluoropropene (HFO-1252zc) and difluoromethane (HFC-32).

In another form thereof, the present disclosure provides an azeotrope or azeotrope-like composition consisting essentially of effective amounts of 1,1-difluoropropene (HFO-1252zc) and 1,1,1,2-tetrafluoroethane (HFC-134a).

In another form thereof, the present disclosure provides an azeotrope or azeotrope-like composition consisting essentially of effective amounts of 1,1-difluoropropene (HFO-1252zc) and 1,1-difluoroethane (HFC-152a).

In another form thereof, the present disclosure provides an azeotrope or azeotrope-like composition consisting essentially of effective amounts of 1,1-difluoropropene (HFO-1252zc) and 2,3,3,3-tetrafluoropropene (HFO-1234yf).

### BRIEF DESCRIPTION OF THE DRAWINGS

FIG. 1 is a schematic representation of an exemplary heat transfer system useful in air conditioning, low temperature refrigeration and medium temperature refrigeration.

FIG. 2 is a schematic representation of an exemplary heat transfer system useful in low and medium temperature refrigeration and which includes a vapor injector.

FIG. 3 is a schematic representation of an exemplary heat transfer system useful in low and medium temperature refrigeration and which includes a liquid injector.

FIG. 4 is a schematic representation of an exemplary heat transfer system useful in low and medium temperature refrigeration and which includes a suction line/liquid line heat exchanger.

FIG. 5 is a schematic representation of an exemplary heat transfer system useful in low and medium temperature refrigeration and which includes a vapor injector and an oil separator.

FIG. 6 corresponds to Examples 1 and 2, showing a graph of PTx measurements for an azeotrope or azeotrope-like composition of difluoromethane (HFC-32) and 1,1-difluoropropene (HFO-1252zc) at an average temperature of −9.5° C.

FIG. 7 corresponds to Example 3 and 4, showing a graph of PTx measurements for an azeotrope or azeotrope-like composition of 1,1-difluoropropene (HFO-1252zc) and 1,1,1,2-tetrafluoroethane (HFC-134a) at an average temperature of −9.4° C.

FIG. 8 corresponds to Examples 5 and 6, showing a graph of PTx measurements for an azeotrope or azeotrope-like composition of 1,1-difluoropropene (HFO-1252zc) and 1,1-difluoroethane (HFC-152a) at an average temperature of 0.2° C.

FIG. 9 corresponds to Examples 7 and 8, showing a graph of PTx measurements for an azeotrope or azeotrope-like composition of 1,1-difluoropropene (HFO-1252zc) and 2,3,3,3-tetrafluoropropene (HFO-1234yf) at an average temperature of −9.3° C.

### DETAILED DESCRIPTION

The present disclosure provides minimum-boiling, homogenous azeotrope or azeotrope-like compositions consisting essentially of 1,1-difluoropropene (HFO-1252zc) and other compounds, including each of difluoromethane (HFC-32), 1,1,1,2-tetrafluoroethane (HFC-134a), 1,1-difluoroethane (HFC-152a), and 2,3,3,3-tetrafluoropropene (HFO-1234yf), and applications or uses for these compositions.

### I. Description of Azeotrope or Azeotrope-Like Compositions

An “azeotrope” composition is a unique combination of two or more components. An azeotrope composition can be characterized in various ways. For example, at a given pressure, an azeotrope composition boils at a constant characteristic temperature which is either greater than the higher boiling point component (maximum boiling azeotrope) or less than the lower boiling point component (minimum boiling azeotrope). At this characteristic temperature the same composition will exist in both the vapor and liquid phases. The azeotrope composition does not fractionate upon boiling or evaporation. Therefore, the components of the azeotrope composition cannot be separated during a phase change.

An azeotrope composition is also characterized in that, at the characteristic azeotrope temperature, the bubble point pressure of the liquid phase is identical to the dew point pressure of the vapor phase.

The behavior of an azeotrope composition is in contrast with that of a non-azeotrope composition in which during boiling or evaporation, the liquid composition changes to a substantial degree.

For the purposes of the present disclosure, an azeotrope composition is characterized as that composition which boils at a constant characteristic temperature, the temperature being lower (a minimum boiling azeotrope) than the boiling points of the two or more components, and thereby having the same composition in both the vapor and liquid phases.

One of ordinary skill in the art would understand however that at different pressures, both the composition and the boiling point of the azeotrope composition will vary to some extent. Therefore, depending on the temperature and/or pressure, an azeotrope composition can have a variable composition. The skilled person would therefore understand that composition ranges, rather than fixed compositions, can be used to define azeotrope compositions. In addition, an azeotrope may be defined in terms of exact weight percentages of each component of the compositions characterized by a fixed boiling point at a specified pressure.

An “azeotrope-like” composition is a composition of two or more components which behaves substantially as an azeotrope composition. Thus, for the purposes of this disclosure, an azeotrope-like composition is a combination of two or more different components which, when in liquid form under given pressure, will boil at a substantially constant temperature, and which will provide a vapor composition substantially identical to the liquid composition undergoing boiling.

Azeotrope or azeotrope-like compositions can be identified using a number of different methods.

Static Vapor-Liquid Equilibrium Methods are a class of experimental techniques that can also be used to identify the presence of azeotrope and azeotrope-like compositions. One such technique, known as the PTx method, collects measurements of the total saturation pressure (“P”) exerted by mixtures of known compositions (“x”) at fixed temperatures (“T”) and cell volumes. (Walas, Phase Equilibria in Chemical Engineering, Butterworth-Heinemann, 1985, pp. 537). Using data collected from the PTx experiment, as well as pure component properties of constituents of the mixtures, the thermodynamic properties of the mixture can be accurately characterized by fitting the component's interaction parameters in a well-defined thermodynamic equation; one such equation is a Helmholtz Energy Equation of State (HEOS) described by E. W. Lemmon et al. (Generalized Model for the Thermodynamic Properties of Mixtures, International Journal of Thermophysics, Vol. 20, 1999, pp. 825-835)

The presence of an azeotrope and its corresponding composition can be observed by plotting saturation pressure measurements from PTx data and saturation pressures described by the HEOS as a function of composition. For a given temperature (isotherm), the presence of an azeotrope composition is identified by the observation of a maximum or minimum in total pressure that is greater or less than the pure saturation pressures of any of the components alone.

The boiling points of each of the components alone are measured at a constant pressure. As the skilled person will appreciate, for a binary azeotrope or azeotrope-like composition, the boiling point of one of the components of the composition is initially measured. The second component of the composition is then added in varying amounts and the boiling point of each of the obtained compositions is measured using the ebulliometer at said constant pressure.

As used herein, the term “consisting essentially of”, with respect to the components of an azeotrope or azeotrope-like composition or mixture, means the composition contains the indicated components in an azeotrope or azeotrope-like ratio, and may contain additional components provided that the additional components do not form new azeotrope or azeotrope-like systems. For example, azeotrope mixtures consisting essentially of two compounds are those that form binary azeotropes, which optionally may include one or more additional components, provided that the additional components do not render the mixture non-azeotropic and do not form an azeotrope with either or both of the compounds (e.g., do not form a ternary or higher azeotrope).

As used herein, the term “about”, when used in connection with recited weight percentages of the components of the present compositions, includes a deviation of ±0.3% from the recited weight percentage.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

As previously discussed, for an azeotrope, at the maximum or minimum boiling point, the composition of the vapor phase will be identical to the composition of the liquid phase. The azeotrope-like composition is therefore that composition of components which provides a substantially constant minimum or maximum boiling point at which substantially constant boiling point the composition of the vapor phase will be substantially identical to the composition of the liquid phase.

### II. Azeotrope and Azeotrope-Like Compositions of 1,1-difluoropropene (HFO-1252zc) and Difluoromethane (HFC-32)

The present disclosure provides a minimum-boiling, homogenous azeotrope or azeotrope-like composition comprising effective amounts of 1,1-difluoropropene (HFO-1252zc) and difluoromethane (HFC-32). The present disclosure particularly provides a minimum-boiling, homogenous azeotrope or azeotrope-like composition consisting essentially of effective amounts of 1,1-difluoropropene (HFO-1252zc) and difluoromethane (HFC-32). The present disclosure provides a minimum-boiling, homogenous azeotrope or azeotrope-like composition consisting of effective amounts of 1,1-difluoropropene (HFO-1252zc) and difluoromethane (HFC-32).

The azeotrope or azeotrope-like composition may comprise from about 1.9 wt. % to about 8.6 wt. % of 1, 1-difluoropropene (HFO-1252zc) and from about 91.4 wt. % to about 98.1 wt. % of difluoromethane (HFC-32) at a temperature of about −28.5° C. to about 49.2° C. and a pressure of about 42.4 psia to about 447.5 psia.

The azeotrope or azeotrope-like composition may consist essentially of from about 1.9 wt. % to about 8.6 wt. % of 1,1-difluoropropene (HFO-1252zc) and from about 91.4 wt. % to about 98.1 wt. % of difluoromethane (HFC-32) at a temperature of about −28.5° C. to about 49.2° C. and a pressure of about 42.4 psia to about 447.5 psia.

The azeotrope or azeotrope-like composition may consist of from about 1.9 wt. % to about 8.6 wt. % of 1, 1-difluoropropene (HFO-1252zc) and from about 91.4 wt. % to about 98.1 wt. % of difluoromethane (HFC-32) at a temperature of about −28.5° C. to about 49.2° C. and a pressure of about 42.4 psia to about 447.5 psia.

The azeotrope or azeotrope-like compositions may comprise of from about 0.01 wt. % to about 25.7 wt. % of 1,1-difluoropropene (HFO-1252zc) and from about 74.3 wt. % to about 99.9 wt. % of difluoromethane (HFC-32), and more specifically, from about 3.1 wt. % to about 14.2 wt. % of 1,1-difluoropropene (HFO-1252zc), from about 85.8 wt. % to about 96.9 wt. % of difluoromethane (HFC-32), from about 5.9 wt. % to about 11.5 wt. % of 1,1-difluoropropene (HFO-1252zc), from about 88.5 wt. % to about 94.1 wt. % of difluoromethane (HFC-32), and still more specifically, about 8.6 wt. % of 1,1-difluoropropene (HFO-1252zc) and about 91.4 wt. % of difluoromethane (HFC-32) at a pressure of about 42.4 psia.

The azeotrope or azeotrope-like compositions may consist essentially of from about 0.01 wt. % to about 25.7 wt. % of 1,1-difluoropropene (HFO-1252zc), from about 74.3 wt. % to about 99.9 wt. % of difluoromethane (HFC-32), from about 3.1 wt. % to about 14.2 wt. % of 1,1-difluoropropene (HFO-1252zc), from about 85.8 wt. % to about 96.9 wt. % of difluoromethane (HFC-32), from about 5.9 wt. % to about 11.5 wt. % of 1,1-difluoropropene (HFO-1252zc), from about 88.5 wt. % to about 94.1 wt. % of difluoromethane (HFC-32), or from about 8.6 wt. % of 1,1-difluoropropene (HFO-1252zc) and about 91.4 wt. % of difluoromethane (HFC-32) at a pressure of about 42.4 psia.

The azeotrope or azeotrope-like compositions may consist of from about 0.01 wt. % to about 25.7 wt. % of 1,1-difluoropropene (HFO-1252zc) and from about 74.3 wt. % to about 99.9 wt. % of difluoromethane (HFC-32), and more specifically, from about 3.1 wt. % to about 14.2 wt. % of 1,1-difluoropropene (HFO-1252zc) and from about 85.8 wt. % to about 96.9 wt. % of difluoromethane (HFC-32), and more particularly, from about 5.9 wt. % to about 11.5 wt. % of 1,1-difluoropropene (HFO-1252zc) and from about 88.5 wt. % to about 94.1 wt. % of difluoromethane (HFC-32), and still more specifically, about 8.6 wt. % of 1,1-difluoropropene (HFO-1252zc) and about 91.4 wt. % of difluoromethane (HFC-32) at a pressure of about 42.4 psia.

In other words, the compositions may comprise 1,1-difluoropropene (HFO-1252zc) in an amount of as much as about 25.7 wt. %, or about 14.2 wt. %, or about 11.5 wt. %, or about 8.6 wt. %, or as little as about 5.9 wt. %, or about 3.1 wt. %, or about 0.01 wt. %, or by any two of the foregoing values as endpoints, for example from about 0.01 wt. % to about 25.7 wt. %, from about 3.1 wt. % to about 14.2 wt. %, from about 5.9 wt. % to about 11.5 wt. %, and/or about 8.6 wt. %, based on the total weight of the 1,1-difluoropropene (HFO-1252zc) and difluoromethane (HFC-32) of the azeotrope or azeotrope-like composition at a pressure of about 42.4 psia.

In other words, the compositions may consist essentially of 1,1-difluoropropene (HFO-1252zc) in an amount of as much as about 25.7 wt. %, or about 14.2 wt. %, or about 11.5 wt. %, or about 8.6 wt. %, or as little as about 5.9 wt. %, or about 3.1 wt. %, or about 0.01 wt. %, or by any two of the foregoing values as endpoints, for example from about 0.01 wt. % to about 25.7 wt. %, from about 3.1 wt. % to about 14.2 wt. %, from about 5.9 wt. % to about 11.5 wt. %, and/or about 8.6 wt. %, based on the total weight of the 1,1-difluoropropene (HFO-1252zc) and difluoromethane (HFC-32) of the azeotrope or azeotrope-like composition at a pressure of about 42.4 psia.

In other words, the compositions may consist of 1,1-difluoropropene (HFO-1252zc) in an amount of as much as about 25.7 wt. %, or about 14.2 wt. %, or about 11.5 wt. %, or about 8.6 wt. %, or as little as about 5.9 wt. %, or about 3.1 wt. %, or about 0.01 wt. %, or by any two of the foregoing values as endpoints, for example from about 0.01 wt. % to about 25.7 wt. %, from about 3.1 wt. % to about 14.2 wt. %, from about 5.9 wt. % to about 11.5 wt. %, and/or about 8.6 wt. %, based on the total weight of the 1,1-difluoropropene (HFO-1252zc) and difluoromethane (HFC-32) of the azeotrope or azeotrope-like composition at a pressure of about 42.4 psia.

In other words, the compositions may comprise difluoromethane (HFC-32) in an amount of as much as about 96.9 wt. %, or about 94.1 wt. %, or about 91.4 wt. %, or as little as about 88.5 wt. %, or about 85.8 wt. %, or about 74.3 wt. %, or by any two of the foregoing values as endpoints, for example from about 74.3 wt. % to about 99.9 wt. %, from about 85.8 wt. % to about 96.9 wt. %, from about 88.5 wt. % to about 94.1 wt. %, and/or about 91.4 wt. %, based on the total weight of the 1,1-difluoropropene (HFO-1252zc) and difluoromethane (HFC-32) of the azeotrope or azeotrope-like composition at a pressure of about 42.4 psia.

In other words, the compositions may consist essentially of difluoromethane (HFC-32) in an amount of as much as about 96.9 wt. %, or about 94.1 wt. %, or about 91.4 wt. %, or as little as about 88.5 wt. %, or about 85.8 wt. %, or about 74.3 wt. %, or by any two of the foregoing values as endpoints, for example from about 74.3 wt. % to about 99.9 wt. %, from about 85.8 wt. % to about 96.9 wt. %, from about 88.5 wt. % to about 94.1 wt. %, and/or about 91.4 wt. %, based on the total weight of the 1,1-difluoropropene (HFO-1252zc) and difluoromethane (HFC-32) of the azeotrope or azeotrope-like composition at a pressure of about 42.4 psia.

In other words, the compositions may consist of difluoromethane (HFC-32) in an amount of as much as about 96.9 wt. %, or about 94.1 wt. %, or about 91.4 wt. %, or as little as about 88.5 wt. %, or about 85.8 wt. %, or about 74.3 wt. %, or by any two of the foregoing values as endpoints, for example from about 74.3 wt. % to about 99.9 wt. %, from about 85.8 wt. % to about 96.9 wt. %, from about 88.5 wt. % to about 94.1 wt. %, and/or about 91.4 wt. %, based on the total weight of the 1,1-difluoropropene (HFO-1252zc) and difluoromethane (HFC-32) of the azeotrope or azeotrope-like composition at a pressure of about 42.4 psia.

The compositions may have azeotropic or azeotrope-like characteristics at a temperature of about −28.5° C., about −19.2° C., about −9.5° C., about 0.2° C., about 9.8° C., about 19.6° C., about 29.5° C., about 39.4° C., or about 49.2° C., or within any range encompassed by any two of the foregoing values as endpoints, for example from about −28.5° C. to about 49.2° C.

The compositions may have azeotropic or azeotrope-like characteristics at a pressure of about 42.4 psia, about 60.9 psia, about 86.2 psia, about 118.5 psia, about 159.7 psia, about 211.6 psia, about 275.8 psia, about 354.4 psia, about 447.5 psia, or within any range encompassed by any two of the foregoing values as endpoints, for example from about 42.4 psia to about 447.5 psia, from about 42.4 psia to about 211.6 psia, from about 60.9 psia to about 275.8 psia, from about 86.2 psia to about 354.4 psia, or from about 118.5 psia to about 447.5 psia.

Specifically, and as described in Table 1 below, the azeotrope or azeotrope-like composition of 1,1-difluoropropene (HFO-1252zc) and difluoromethane (HFC-32) may correlate with pressure (psia) and saturation temperature (° C.).

In column (i) of Table 1 below, azeotrope-like composition ranges may depend as based upon the method used to determine such range. Specifically, (i) temperature glide is the difference between the saturated vapor temperature and the saturated liquid temperature at a fixed pressure in thermodynamic equilibrium. Consequently, an azeotrope composition may have a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This method was used to determine the relative compositions in column (i) of Table 1 below, which may be regarded as the broadest azeotrope-like composition range.

In column (ii) of Table 1 below, the relative volatility is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This may be regarded as an intermediate azeotrope-like composition range.

In column (iii) of Table 1 below a relative volatility of 1.05 is substantially close to 1.0 and therefore, compositions that satisfy such relative volatility are considered azeotrope-like. This may be regarded as the narrowest azeotrope-like composition range.

Column (1) of table 1 below describes the azeotrope composition that, at a given pressure, the azeotrope composition boils at a constant characteristic temperature which is less than the lower boiling point component (minimum boiling azeotrope). At this characteristic temperature the same composition will exist in both the vapor and liquid phases. Therefore, the components of the azeotrope composition cannot be separated during a phase change and are regarded as the azeotrope composition. Such compositional values are presented in Column (1) of Table 1 below corresponding to each pressure and saturation temperature.

According, and in view of the foregoing, the azeotrope or azeotrope-like composition of 1,1-difluoropropene (HFO-1252zc) and difluoromethane (HFC-32) may comprise any of the values as described in each of columns (1), (i), (ii) or (iii) in each row of Table 1 below.

The azeotrope or azeotrope-like composition of 1,1-difluoropropene (HFO-1252zc) and difluoromethane (HFC-32) may consist essentially of any of the values as described in each of columns (1), (i), (ii) or (iii) in each row of Table 1 below.

The azeotrope or azeotrope-like composition of 1,1-difluoropropene (HFO-1252zc) and difluoromethane (HFC-32) may consist of any of the values described in each of columns (1), (i), (ii) or (iii) in each row of Table 1 below.

TABLE 1
Azeotrope Composition and (2) Azeotrope-like composition ranges
of 1,1-difluoropropene (HFO-1252zc) and difluoromethane (HFC-32)

| | | | | (2) Azeotropic-Like Composition Range | | | | | |
|---|---|---|---|---|---|---|---|---|---|
| | | (1) Azeotropic | | (i) | | (ii) | | (iii) | |
| | | Composition | | Temp Glide <0.5° C. | | Rel. Vol. <1.1 | | Rel. Vol. <1.05 | |
| Sat. | Sat. | | Wt. % | | Wt. % | | Wt. % | | Wt. % |
| Pres. | Temp. | Wt. % | HFO- | Wt. % | HFO- | Wt. % | HFO- | Wt. % | HFO- |
| (psia) | (° C.) | HFC-32 | 1252zc | HFC-32 | 1252zc | HFC-32 | 1252zc | HFC-32 | 1252zc |
| 42.4 | −28.5 | 91.4 | 8.6 | 74.3 to | 0.01 to | 85.8 to | 3.1 to | 88.5 to | 5.9 to |
| | | | | 99.9 | 25.7 | 96.9 | 14.2 | 94.1 | 11.5 |
| 60.9 | −19.2 | 93.6 | 6.4 | 75.3 to | 0.01 to | 87.5 to | 0.4 to | 90.5 to | 3.4 to |
| | | | | 99.9 | 24.7 | 99.6 | 12.5 | 96.6 | 9.5 |
| 86.2 | −9.5 | 95.9 | 4.1 | 76.2 to | 0.01 to | 89.2 to | 0.01 to | 92.4 to | 0.8 to |
| | | | | 99.9 | 23.8 | 99.9 | 10.8 | 99.2 | 7.6 |
| 118.5 | 0.2 | 98.1 | 1.9 | 77.0 to | 0.01 to | 90.8 to | 0.01 to | 94.9 to | 0.01 to |
| | | | | 99.9 | 23.0 | 99.9 | 9.2 | 99.9 | 5.1 |
| 159.7 | 9.8 | — | — | 77.8 to | 0.01 to | 92.3 to | 0.01 to | 96.2 to | 0.01 to |
| | | | | 99.9 | 22.2 | 99.9 | 7.7 | 99.9 | 3.8 |
| 211.6 | 19.6 | — | — | 78.4 to | 0.01 to | 93.6 to | 0.01 to | 98.0 to | 0.01 to |
| | | | | 99.9 | 21.6 | 99.9 | 6.4 | 99.9 | 2.0 |
| 275.8 | 29.5 | — | — | 78.8 to | 0.01 to | 94.5 to | 0.01 to | 99.5 to | 0.01 to |
| | | | | 99.9 | 21.2 | 99.9 | 5.5 | 99.9 | 0.5 |
| 354.4 | 39.4 | — | — | 78.9 to | 0.01 to | 95.2 to | 0.01 to | — | — |
| | | | | 99.9 | 21.1 | 99.9 | 4.8 | | |
| 447.5 | 49.2 | — | — | 78.6 to | 0.01 to | 95.0 to | 0.01 to | — | — |
| | | | | 99.9 | 21.4 | 99.9 | 5.0 | | |

### III. Azeotrope and Azeotrope-Like Compositions of 1,1-difluoropropene (HFO-1252zc) and 1,1, 1,2-tetrafluoroethane (HFC-134a)

The present disclosure provides a minimum-boiling, homogenous azeotrope or azeotrope-like composition comprising effective amounts of 1,1-difluoropropene (HFO-1252zc) and 1,1,1,2-tetrafluoroethane (HFC-134a). The present disclosure particularly provides a minimum-boiling, homogenous azeotrope or azeotrope-like composition consisting essentially of effective amounts of 1,1-difluoropropene (HFO-1252zc) and 1,1,1,2-tetrafluoroethane (HFC-134a). The present disclosure provides a minimum-boiling, homogenous azeotrope or azeotrope-like composition consisting of effective amounts of 1,1-difluoropropene (HFO-1252zc) and 1,1,1, 2-tetrafluoroethane (HFC-134a).

The azeotrope or azeotrope-like composition may comprise from about 36.9 wt. % to about 59.6 wt. % of 1,1-difluoropropene (HFO-1252zc) and from about 40.4 wt. % to about 63.1 wt. % of 1,1,1,2-tetrafluoroethane (HFC-134a) at a temperature of about −29.4° C. to about 78.9° C. and a pressure of about 16.6 psia to about 403.5 psia.

The azeotrope or azeotrope-like composition may consist essentially of from about 36.9 wt. % to about 59.6 wt. % of 1,1-difluoropropene (HFO-1252zc) and from about 40.4 wt. % to about 63.1 wt. % of 1,1,1,2-tetrafluoroethane (HFC-134a) at a temperature of about −29.4° C. to about 78.9° C. and a pressure of about 16.6 psia to about 403.5 psia.

The azeotrope or azeotrope-like composition may consist of from about 36.9 wt. % to about 59.6 wt. % of 1,1-difluoropropene (HFO-1252zc) and from about 40.4 wt. % to about 63.1 wt. % of 1,1,1,2-tetrafluoroethane (HFC-134a) at a temperature of about −29.4° C. to about 78.9° C. and a pressure of about 16.6 psia to about 403.5 psia.

The azeotrope or azeotrope-like compositions may comprise of from about 0.1 wt. % to about 99.9 wt. % of 1,1-difluoropropene (HFO-1252zc) and from about 0.1 wt. % to about 99.9 wt. % of 1,1,1,2-tetrafluoroethane (HFC-134a), and more specifically, from about 15.0 wt. % to about 63.5 wt. % of 1,1-difluoropropene (HFO-1252zc) and from about 36.5 wt. % to about 85.0 wt. % of 1,1,1,2-tetrafluoroethane (HFC-134a), and more particularly, from about 25.3 wt. % to about 49.7 wt. % of 1,1-difluoropropene (HFO-1252zc) and from about 50.3 wt. % to about 74.7 wt. % of 1,1,1,2-tetrafluoroethane (HFC-134a), and still more specifically, about 36.9 wt. % of 1,1-difluoropropene (HFO-1252zc) and about 63.1 wt. % of 1,1,1,2-tetrafluoroethane (HFC-134a) at a pressure of about 403.5 psia.

The azeotrope or azeotrope-like compositions may consist essentially of from about 0.1 wt. % to about 99.9 wt. % of 1,1-difluoropropene (HFO-1252zc) and from about 0.1 wt. % to about 99.9 wt. % of 1,1,1,2-tetrafluoroethane (HFC-134a), and more specifically, from about 15.0 wt. % to about 63.5 wt. % of 1,1-difluoropropene (HFO-1252zc) and from about 36.5 wt. % to about 85.0 wt. % of 1,1,1,2-tetrafluoroethane (HFC-134a), and more particularly, from about 25.3 wt. % to about 49.7 wt. % of 1,1-difluoropropene (HFO-1252zc) and from about 50.3 wt. % to about 74.7 wt. % of 1,1,1,2-tetrafluoroethane (HFC-134a), and still more specifically, about 36.9 wt. % of 1,1-difluoropropene (HFO-1252zc) and about 63.1 wt. % of 1,1,1,2-tetrafluoroethane (HFC-134a) at a pressure of about 403.5 psia.

The azeotrope or azeotrope-like compositions may consist of from about 0.1 wt. % to about 99.9 wt. % of 1,1-difluoropropene (HFO-1252zc) and from about 0.1 wt. % to about 99.9 wt. % of 1, 1,1,2-tetrafluoroethane (HFC-134a), and more specifically, from about 15.0 wt. % to about 63.5 wt. % of 1,1-difluoropropene (HFO-1252zc) and from about 36.5 wt. % to about 85.0 wt. % of 1,1,1,2-tetrafluoroethane (HFC-134a), and more particularly, from about 25.3 wt. % to about 49.7 wt. % of 1,1-difluoropropene (HFO-1252zc) and from about 50.3 wt. % to about 74.7 wt. % of 1,1,1,2-tetrafluoroethane (HFC-134a), and still more specifically, about 36.9 wt. % of 1,1-difluoropropene (HFO-1252zc) and about 63.1 wt. % of 1,1,1,2-tetrafluoroethane (HFC-134a) at a pressure of about 403.5 psia.

In other words, the compositions may comprise 1,1-difluoropropene (HFO-1252zc) in an amount of as much as about 99.9 wt. %, or about 63.5 wt. %, or about 49.7 wt. %, or about 36.9 wt. %, or as little as about 25.3 wt. %, or about 15.0 wt. %, or about 0.1 wt. %, or by any two of the foregoing values as endpoints, for example from about 0.1 wt. % to about 99.9 wt. %, from about 15.0 wt. % to about 63.5 wt. %, from about 25.3 wt. % to about 49.7 wt. %, and/or about 36.9 wt. %, based on the total weight of the 1,1-difluoropropene (HFO-1252zc) and 1,1,1,2-tetrafluoroethane (HFC-134a) of the azeotrope or azeotrope-like composition at a pressure of about 403.5 psia.

In other words, the compositions may consist essentially of 1,1-difluoropropene (HFO-1252zc) in an amount of as much as about 99.9 wt. %, or about 63.5 wt. %, or about 49.7 wt. %, or about 36.9 wt. %, or as little as about 25.3 wt. %, or about 15.0 wt. %, or about 0.1 wt. %, or by any two of the foregoing values as endpoints, for example from about 0.1 wt. % to about 99.9 wt. %, from about 15.0 wt. % to about 63.5 wt. %, from about 25.3 wt. % to about 49.7 wt. %, and/or about 36.9 wt. %, based on the total weight of the 1,1-difluoropropene (HFO-1252zc) and 1,1,1,2-tetrafluoroethane (HFC-134a) of the azeotrope or azeotrope-like composition at a pressure of about 403.5 psia.

In other words, the compositions may consist of 1,1-difluoropropene (HFO-1252zc) in an amount of as much as about 99.9 wt. %, or about 63.5 wt. %, or about 49.7 wt. %, or about 36.9 wt. %, or as little as about 25.3 wt. %, or about 15.0 wt. %, or about 0.1 wt. %, or by any two of the foregoing values as endpoints, for example from about 0.1 wt. % to about 99.9 wt. %, from about 15.0 wt. % to about 63.5 wt. %, from about 25.3 wt. % to about 49.7 wt. %, and/or about 36.9 wt. %, based on the total weight of the 1,1-difluoropropene (HFO-1252zc) and 1,1,1,2-tetrafluoroethane (HFC-134a) of the azeotrope or azeotrope-like composition at a pressure of about 403.5 psia.

In other words, the compositions may consist essentially of 1,1,1,2-tetrafluoroethane (HFC-134a) in an amount of as much as about 99.9 wt. %, or about 85.0 wt. %, or about 74.7 wt. %, or about 63.1 wt. %, or as little as about 50.3 wt. %, or about 36.5 wt. %, or about 0.1 wt. %, or by any two of the foregoing values as endpoints, for example from about 0.1 wt. % to about 99.9 wt. %, from about 36.5 wt. % to about 85.0 wt. %, from about 50.3 wt. % to about 74.7 wt. %, and/or about 63.1 wt. %, based on the total weight of the 1,1-difluoropropene (HFO-1252zc) and 1,1,1,2-tetrafluoroethane (HFC-134a) of the azeotrope or azeotrope-like composition at a pressure of about 403.5 psia.

In other words, the compositions may consist of 1,1,1,2-tetrafluoroethane (HFC-134a) in an amount of as much as about 99.9 wt. %, or about 85.0 wt. %, or about 74.7 wt. %, or about 63.1 wt. %, or as little as about 50.3 wt. %, or about 36.5 wt. %, or about 0.1 wt. %, or by any two of the foregoing values as endpoints, for example from about 0.1 wt. % to about 99.9 wt. %, from about 36.5 wt. % to about 85.0 wt. %, from about 50.3 wt. % to about 74.7 wt. %, and/or about 63.1 wt. %, based on the total weight of the 1,1-difluoropropene (HFO-1252zc) and 1,1,1,2-tetrafluoroethane (HFC-134a) of the azeotrope or azeotrope-like composition at a pressure of about 403.5 psia.

The compositions may have azeotropic or azeotrope-like characteristics at a temperature of about 78.9° C., about 68.9° C., about 59.0° C., about 49.3° C., about 39.4° C., about 29.5° C., about 19.6° C., about 9.9° C., about 0.3° C., about −9.4° C., about −19.1° C., about −29.4° C., or within any range encompassed by any two of the foregoing values as endpoints, for example from about −29.4° C. to about 78.9° C.

The compositions may have azeotropic or azeotrope-like characteristics at a pressure of about 403.5 psia, about 326.2 psia, about 261.8 psia, about 208.5 psia, about 163.4 psia, about 125.6 psia, about 95.1 psia, about 70.8 psia, about 51.7 psia, about 36.9 psia, about 25.4 psia, about 16.6 psia, or within any range encompassed by any two of the foregoing values as endpoints, for example from about 16.6 psia to about 403.5 psia.

Specifically, and as described in Table 2 below, the azeotrope or azeotrope-like composition of 1,1-difluoropropene (HFO-1252zc) and 1,1,1,2-tetrafluoroethane (HFC-134a) may correlate with pressure (psia) and saturation temperature (° C.).

In column (i) of Table 2 below, azeotrope-like composition ranges may depend as based upon the method used to determine such range. Specifically, (i) temperature glide is the difference between the saturated vapor temperature and the saturated liquid temperature at a fixed pressure in thermodynamic equilibrium. Consequently, an azeotrope composition may have a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This method was used to determine the relative compositions in column (i) of Table 1 below, which may be regarded as the broadest azeotrope-like composition range.

In column (ii) of Table 2 below, the relative volatility is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This may be regarded as an intermediate azeotrope-like composition range.

In column (iii) of Table 2 below a relative volatility of 1.05 is substantially close to 1.0 and therefore, compositions that satisfy such relative volatility are considered azeotrope-like. This may be regarded as the narrowest azeotrope-like composition range.

Column (1) of Table 2 below describes the azeotrope composition that, at a given pressure, the azeotrope composition boils at a constant characteristic temperature which is less than the lower boiling point component (minimum boiling azeotrope). At this characteristic temperature the same composition will exist in both the vapor and liquid phases. Therefore, the components of the azeotrope composition cannot be separated during a phase change and are regarded as the azeotrope composition. Such compositional values are presented in Column (1) of Table 2 below corresponding to each pressure and saturation temperature.

According, and in view of the foregoing, the azeotrope or azeotrope-like composition of 1, 1-difluoropropene (HFO-1252zc) and 1, 1, 1,2-tetrafluoroethane (HFC-134a) may comprise any of the values as described in each of columns (1), (i), (ii) or (iii) in each row of Table 2 below.

The azeotrope or azeotrope-like composition of 1,1-difluoropropene (HFO-1252zc) and 1, 1, 1,2-tetrafluoroethane (HFC-134a) may consist essentially of any of the values as described in each of columns (1), (i), (ii) or (iii) in each row of Table 2 below.

The azeotrope or azeotrope-like composition of 1,1-difluoropropene (HFO-1252zc) and 1,1,1,2-tetrafluoroethane (HFC-134a) may consist of any of the values described in each of columns (1), (i), (ii) or (iii) in each row of Table 2 below.

TABLE 2
Azeotrope Composition and (2) Azeotrope-like composition ranges of 1,1-
difluoropropene (HFO-1252zc) and 1,1,1,2-tetrafluoroethane (HFC-134a):

| | | | | (2) Azeotropic-Like Composition Range | | | | | |
|---|---|---|---|---|---|---|---|---|---|
| | | (1) Azeotropic | | (i) | | (ii) | | (iii) | |
| | | Composition | | Glide <0.5° C. | | Rel. Vol. <1.1 | | Rel. Vol. <1.05 | |
| Sat. | Sat. | Wt. % | Wt. % | Wt. % | Wt. % | Wt. % | Wt. % | Wt. % | Wt. % |
| Pres. | Temp. | HFO- | HFC- | HFO- | HFC- | HFO- | HFC- | HFO- | HFC- |
| (psia) | (° C.) | 1252zc | 134a | 1252zc | 134a | 1252zc | 134a | 1252zc | 134a |
| 16.6 | −29.4 | 59.6 | 40.4 | 36.1 to | 0.1 to | 50.8 to | 30.9 to | 55.0 to | 35.7 to |
| | | | | 99.9 | 63.9 | 69.1 | 49.2 | 64.3 | 45.0 |
| 25.4 | −19.1 | 56.7 | 43.3 | 32.7 to | 0.1 to | 47.4 to | 33.3 to | 51.9 to | 38.3 to |
| | | | | 99.9 | 67.3 | 66.7 | 52.6 | 61.7 | 48.1 |
| 36.9 | −9.4 | 54.2 | 45.8 | 29.6 to | 0.1 to | 44.4 to | 35.3 to | 49.1 to | 40.6 to |
| | | | | 99.9 | 70.4 | 64.7 | 55.6 | 59.4 | 50.9 |
| 51.7 | 0.3 | 51.9 | 48.1 | 26.3 to | 0.1 to | 41.6 to | 37.0 to | 46.5 to | 42.6 to |
| | | | | 99.9 | 73.7 | 63.0 | 58.4 | 57.4 | 53.5 |
| 70.8 | 9.9 | 49.6 | 50.4 | 22.8 to | 0.1 to | 38.8 to | 38.5 to | 43.9 to | 44.5 to |
| | | | | 99.9 | 77.2 | 61.5 | 61.2 | 55.5 | 56.1 |
| 95.1 | 19.6 | 47.5 | 52.5 | 18.6 to | 0.1 to | 36.0 to | 39.8 to | 41.5 to | 46.2 to |
| | | | | 99.9 | 81.4 | 60.2 | 64.0 | 53.8 | 58.5 |
| 125.6 | 29.5 | 45.5 | 54.5 | 0.1 to | 0.1 to | 33.1 to | 40.8 to | 39.0 to | 47.8 to |
| | | | | 99.9 | 99.9 | 59.2 | 66.9 | 52.2 | 61.0 |
| 163.4 | 39.4 | 43.6 | 56.4 | 0.1 to | 0.1 to | 30.2 to | 41.6 to | 36.6 to | 49.1 to |
| | | | | 99.9 | 99.9 | 58.4 | 69.8 | 50.9 | 63.4 |
| 208.5 | 49.3 | 41.8 | 58.2 | 0.1 to | 0.1 to | 27.2 to | 41.9 to | 34.1 to | 50.2 to |
| | | | | 99.9 | 99.9 | 58.1 | 72.8 | 49.8 | 65.9 |
| 261.8 | 59 | 40.1 | 59.9 | 0.1 to | 0.1 to | 24.0 to | 41.5 to | 31.6 to | 50.9 to |
| | | | | 99.9 | 99.9 | 58.5 | 76.0 | 49.1 | 68.4 |
| 326.2 | 68.9 | 38.5 | 61.5 | 0.1 to | 0.1 to | 20.1 to | 40.2 to | 28.8 to | 51.1 to |
| | | | | 99.9 | 99.9 | 59.8 | 79.9 | 48.9 | 71.2 |
| 403.5 | 78.9 | 36.9 | 63.1 | 0.1 to | 0.1 to | 15.0 to | 36.5 to | 25.3 to | 50.3 to |
| | | | | 99.9 | 99.9 | 63.5 | 85.0 | 49.7 | 74.7 |

### IV. Azeotrope and Azeotrope-Like Compositions of 1,1-difluoropropene (HFO-1252zc) and 1,1-difluoroethane (HFC-152a)

The present disclosure provides a minimum-boiling, homogenous azeotrope or azeotrope-like composition comprising effective amounts of 1,1-difluoropropene (HFO-1252zc) and 1,1-difluoroethane (HFC-152a). The present disclosure particularly provides a minimum-boiling, homogenous azeotrope or azeotrope-like composition consisting essentially of effective amounts of 1,1-difluoropropene (HFO-1252zc) and 1,1-difluoroethane (HFC-152a). The present disclosure provides a minimum-boiling, homogenous azeotrope or azeotrope-like composition consisting of effective amounts of 1,1-difluoropropene (HFO-1252zc) and 1,1-difluoroethane (HFC-152a).

The azeotrope or azeotrope-like composition may comprise from about 64.6 wt. % to about 80.1 wt. % of 1,1-difluoropropene (HFO-1252zc) and from about 19.9 wt. % to about 35.4 wt. % of 1,1-difluoroethane (HFC-152a) at a temperature of about −29.4° C. to about 78.9° C. and a pressure of about 16.0 psia to about 375.8 psia.

The azeotrope or azeotrope-like composition may consist essentially of from about 64.6 wt. % to about 80.1 wt. % of 1,1-difluoropropene (HFO-1252zc) and from about 19.9 wt. % to about 35.4 wt. % of 1,1-difluoroethane (HFC-152a) at a temperature of about −29.4° C. to about 78.9° C. and a pressure of about 16.0 psia to about 375.8 psia.

The azeotrope or azeotrope-like composition may consist of from about 64.6 wt. % to about 80.1 wt. % of 1,1-difluoropropene (HFO-1252zc) and from about 19.9 wt. % to about 35.4 wt. % of 1,1-difluoroethane (HFC-152a) at a temperature of about −29.4° C. to about 78.9° C. and a pressure of about 16.0 psia to about 375.8 psia.

The azeotrope or azeotrope-like compositions may comprise of from about 0.1 wt. % to about 99.9 wt. % of 1,1-difluoropropene (HFO-1252zc) and from about 0.1 wt. % to about 99.9 wt. % of 1,1-difluoroethane (HFC-152a), and more specifically, from about 38.0 wt. % to about 90.0 wt. % of 1,1-difluoropropene (HFO-1252zc) and from about 10.0 wt. % to about 62.0 wt. % of 1,1-difluoroethane (HFC-152a), from about 51.2 wt. % to about 77.6 wt. % of 1,1-difluoropropene (HFO-1252zc) and from about 22.4 wt. % to about 48.8 wt. % of 1,1-difluoroethane (HFC-152a), and still more specifically, about 64.6 wt. % of 1,1-difluoropropene (HFO-1252zc) and about 35.4 wt. % of 1,1-difluoroethane (HFC-152a) at a pressure of about 375.8 psia.

The azeotrope or azeotrope-like compositions may consist essentially of from about 0.1 wt. % to about 99.9 wt. % of 1,1-difluoropropene (HFO-1252zc) and from about 0.1 wt. % to about 99.9 wt. % of 1,1-difluoroethane (HFC-152a), and more specifically, from about 38.0 wt. % to about 90.0 wt. % of 1,1-difluoropropene (HFO-1252zc) and from about 10.0 wt. % to about 62.0 wt. % of 1,1-difluoroethane (HFC-152a), from about 51.2 wt. % to about 77.6 wt. % of 1,1-difluoropropene (HFO-1252zc) and from about 22.4 wt. % to about 48.8 wt. % of 1,1-difluoroethane (HFC-152a), and still more specifically, about 64.6 wt. % of 1,1-difluoropropene (HFO-1252zc) and about 35.4 wt. % of 1,1-difluoroethane (HFC-152a) at a pressure of about 375.8 psia.

The azeotrope or azeotrope-like compositions may consist of from about 0.1 wt. % to about 99.9 wt. % of 1,1-difluoropropene (HFO-1252zc) and from about 0.1 wt. % to about 99.9 wt. % of 1,1-difluoroethane (HFC-152a), and more specifically, from about 38.0 wt. % to about 90.0 wt. % of 1,1-difluoropropene (HFO-1252zc) and from about 10.0 wt. % to about 62.0 wt. % of 1,1-difluoroethane (HFC-152a), from about 51.2 wt. % to about 77.6 wt. % of 1, 1-difluoropropene (HFO-1252zc) and from about 22.4 wt. % to about 48.8 wt. % of 1, 1-difluoroethane (HFC-152a), and still more specifically, about 64.6 wt. % of 1,1-difluoropropene (HFO-1252zc) and about 35.4 wt. % of 1,1-difluoroethane (HFC-152a) at a pressure of about 375.8 psia.

In other words, the compositions may comprise 1,1-difluoropropene (HFO-1252zc) in an amount of as much as about 99.9 wt. %, or about 90.0 wt. %, or about 77.6 wt. %, or about 64.6 wt. %, or as little as about 51.2 wt. %, or about 38.0 wt. %, or about 0.1 wt. %, or by any two of the foregoing values as endpoints, for example from about 0.1 wt. % to about 99.9 wt. %, from about 38.0 wt. % to about 90.0 wt. %, from about 51.2 wt. % to about 77.6 wt. %, and/or about 64.6 wt. %, based on the total weight of the 1,1-difluoropropene (HFO-1252zc) and 1,1-difluoroethane (HFC-152a) of the azeotrope or azeotrope-like composition at a pressure of about 375.8 psia.

In other words, the compositions may consist essentially of 1,1-difluoropropene (HFO-1252zc) in an amount of as much as about 99.9 wt. %, or about 90.0 wt. %, or about 77.6 wt. %, or about 64.6 wt. %, or as little as about 51.2 wt. %, or about 38.0 wt. %, or about 0.1 wt. %, or by any two of the foregoing values as endpoints, for example from about 0.1 wt. % to about 99.9 wt. %, from about 38.0 wt. % to about 90.0 wt. %, from about 51.2 wt. % to about 77.6 wt. %, and/or about 64.6 wt. %, based on the total weight of the 1,1-difluoropropene (HFO-1252zc) and 1,1-difluoroethane (HFC-152a) of the azeotrope or azeotrope-like composition at a pressure of about 375.8 psia.

In other words, the compositions may consist of 1,1-difluoropropene (HFO-1252zc) in an amount of as much as about 99.9 wt. %, or about 90.0 wt. %, or about 77.6 wt. %, or about 64.6 wt. %, or as little as about 51.2 wt. %, or about 38.0 wt. %, or about 0.1 wt. %, or by any two of the foregoing values as endpoints, for example from about 0.1 wt. % to about 99.9 wt. %, from about 38.0 wt. % to about 90.0 wt. %, from about 51.2 wt. % to about 77.6 wt. %, and/or about 64.6 wt. %, based on the total weight of the 1,1-difluoropropene (HFO-1252zc) and 1,1-difluoroethane (HFC-152a) of the azeotrope or azeotrope-like composition at a pressure of about 375.8 psia.

In other words, the compositions may comprise 1, 1-difluoroethane (HFC-152a) in an amount of as much as about 99.9 wt. %, or about 62.0 wt. %, or about 48.8 wt. %, or about 35.4 wt. %, or as little as about 22.4 wt. %, or about 10.0 wt. %, or about 0.1 wt. %, or by any two of the foregoing values as endpoints, for example from about 0.1 wt. % to about 99.9 wt. %, from about 10.0 wt. % to about 62.0 wt. %, from about 22.4 wt. % to about 48.8 wt. %, and/or about 35.4 wt. %, based on the total weight of the 1,1-difluoropropene (HFO-1252zc) and 1,1-difluoroethane (HFC-152a) of the azeotrope or azeotrope-like composition at a pressure of about 375.8 psia.

In other words, the compositions may consist essentially of 1,1-difluoroethane (HFC-152a) in an amount of as much as about 99.9 wt. %, or about 62.0 wt. %, or about 48.8 wt. %, or about 35.4 wt. %, or as little as about 22.4 wt. %, or about 10.0 wt. %, or about 0.1 wt. %, or by any two of the foregoing values as endpoints, for example from about 0.1 wt. % to about 99.9 wt. %, from about 10.0 wt. % to about 62.0 wt. %, from about 22.4 wt. % to about 48.8 wt. %, and/or about 35.4 wt. %, based on the total weight of the 1,1-difluoropropene (HFO-1252zc) and 1,1-difluoroethane (HFC-152a) of the azeotrope or azeotrope-like composition at a pressure of about 375.8 psia.

In other words, the compositions may consist of 1,1-difluoroethane (HFC-152a) in an amount of as much as about 99.9 wt. %, or about 62.0 wt. %, or about 48.8 wt. %, or about 35.4 wt. %, or as little as about 22.4 wt. %, or about 10.0 wt. %, or about 0.1 wt. %, or by any two of the foregoing values as endpoints, for example from about 0.1 wt. % to about 99.9 wt. %, from about 10.0 wt. % to about 62.0 wt. %, from about 22.4 wt. % to about 48.8 wt. %, and/or about 35.4 wt. %, based on the total weight of the 1,1-difluoropropene (HFO-1252zc) and 1,1-difluoroethane (HFC-152a) of the azeotrope or azeotrope-like composition at a pressure of about 375.8 psia.

The compositions may have azeotropic or azeotrope-like characteristics at a temperature of about 78.9° C., about 68.9° C., about 59.0° C., about 49.3° C., about 39.4° C., about 29.5° C., about 19.6° C., about 9.9° C., about 0.2° C., about −9.4° C., about −19.2° C., about −29.4° C., or within any range encompassed by any two of the foregoing values as endpoints, for example from about −29.4° C. to about 78.9° C.

The compositions may have azeotropic or azeotrope-like characteristics at a pressure of about 375.8 psia, about 305.4 psia, about 245.3 psia, about 195.9 psia, about 153.8 psia, about 118.6 psia, about 90.0 psia, about 67.1 psia, about 49.3 psia, about 35.2 psia, about 24.3 psia, about 16.0 psia, or within any range encompassed by any two of the foregoing values as endpoints, for example from about 16.0 psia to about 375.8 psia.

Specifically, and as described in Table 3 below, the azeotrope or azeotrope-like composition of 1,1-difluoropropene (HFO-1252zc) and 1,1-difluoroethane (HFC-152a) may correlate with pressure (psia) and saturation temperature (° C.).

In column (i) of Table 3 below, azeotrope-like composition ranges may depend as based upon the method used to determine such range. Specifically, (i) temperature glide is the difference between the saturated vapor temperature and the saturated liquid temperature at a fixed pressure in thermodynamic equilibrium. Consequently, an azeotrope composition may have a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This method was used to determine the relative compositions in column (i) of Table 1 below, which may be regarded as the broadest azeotrope-like composition range.

In column (ii) of Table 3 below, the relative volatility is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This may be regarded as an intermediate azeotrope-like composition range.

In column (iii) of Table 3 below a relative volatility of 1.05 is substantially close to 1.0 and therefore, compositions that satisfy such relative volatility are considered azeotrope-like. This may be regarded as the narrowest azeotrope-like composition range.

Column (1) of Table 3 below describes the azeotrope composition that, at a given pressure, the azeotrope composition boils at a constant characteristic temperature which is less than the lower boiling point component (minimum boiling azeotrope). At this characteristic temperature the same composition will exist in both the vapor and liquid phases. Therefore, the components of the azeotrope composition cannot be separated during a phase change and are regarded as the azeotrope composition. Such compositional values are presented in Column (1) of Table 3 below corresponding to each pressure and saturation temperature.

According, and in view of the foregoing, the azeotrope or azeotrope-like composition of 1,1-difluoropropene (HFO-1252zc) and 1,1-difluoroethane (HFC-152a) may comprise any of the values as described in each of columns (1), (i), (ii) or (iii) in each row of Table 3 below.

The azeotrope or azeotrope-like composition of 1,1-difluoropropene (HFO-1252zc) and 1,1-difluoroethane (HFC-152a) may consist essentially of any of the values as described in each of columns (1), (i), (ii) or (iii) in each row of Table 3 below.

The azeotrope or azeotrope-like composition of 1,1-difluoropropene (HFO-1252zc) and 1,1-difluoroethane (HFC-152a) may consist of any of the values described in each of columns (1), (i), (ii) or (iii) in each row of Table 3 below.

TABLE 3
Azeotrope Composition and (2) Azeotrope-like composition ranges of
1,1-difluoropropene (HFO-1252zc) and 1,1-difluoroethane (HFC-152a):

| | | | | (2) Azeotropic-Like Composition Range | | | | | |
|---|---|---|---|---|---|---|---|---|---|
| | | (1) Azeotropic | | (i) | | (ii) | | (iii) | |
| | | Composition | | Glide <0.5° C. | | Rel. Vol. <1.1 | | Rel. Vol. <1.05 | |
| Sat. | Sat. | Wt. % | Wt. % | Wt. % | Wt. % | Wt. % | Wt. % | Wt. % | Wt. % |
| Pres. | Temp. | HFO- | HFC- | HFO- | HFC- | HFO- | HFC- | HFO- | HFC- |
| (psia) | (° C.) | 1252zc | 152a | 1252zc | 152a | 1252zc | 152a | 1252zc | 152a |
| 16 | −29.4 | 80.1 | 19.9 | 55.4 to | 0.1 to | 71.5 to | 11.7 to | 75.7 to | 15.7 to |
| | | | | 99.9 | 44.6 | 88.3 | 28.5 | 84.3 | 24.3 |
| 24.3 | −19.2 | 78.4 | 21.6 | 52.8 to | 0.1 to | 69.1 to | 12.7 to | 73.7 to | 17.0 to |
| | | | | 99.9 | 47.2 | 87.3 | 30.9 | 83.0 | 26.3 |
| 35.2 | −9.4 | 76.9 | 23.1 | 50.3 to | 0.1 to | 66.8 to | 13.5 to | 71.7 to | 18.2 to |
| | | | | 99.9 | 49.7 | 86.5 | 33.2 | 81.8 | 28.3 |
| 49.3 | 0.2 | 75.4 | 24.6 | 47.6 to | 0.1 to | 64.5 to | 14.2 to | 69.8 to | 19.3 to |
| | | | | 99.9 | 52.4 | 85.8 | 35.5 | 80.7 | 30.2 |
| 67.1 | 9.9 | 73.9 | 26.1 | 44.8 to | 0.1 to | 62.1 to | 14.8 to | 67.9 to | 20.3 to |
| | | | | 99.9 | 55.2 | 85.2 | 37.9 | 79.7 | 32.1 |
| 90 | 19.6 | 72.5 | 27.5 | 41.7 to | 0.1 to | 59.5 to | 15.2 to | 65.9 to | 21.2 to |
| | | | | 99.9 | 58.3 | 84.8 | 40.5 | 78.8 | 34.1 |
| 118.6 | 29.5 | 71 | 29 | 38.2 to | 0.1 to | 56.9 to | 15.5 to | 63.9 to | 22.1 to |
| | | | | 99.9 | 61.8 | 84.5 | 43.1 | 77.9 | 36.1 |
| 153.8 | 39.4 | 69.6 | 30.4 | 33.9 to | 0.1 to | 54.0 to | 15.6 to | 61.7 to | 22.8 to |
| | | | | 99.9 | 66.1 | 84.4 | 46.0 | 77.2 | 38.3 |
| 195.9 | 49.3 | 68.3 | 31.7 | 27.9 to | 0.1 to | 50.9 to | 15.3 to | 59.5 to | 23.3 to |
| | | | | 99.9 | 72.1 | 84.7 | 49.1 | 76.7 | 40.5 |
| 245.3 | 59 | 67 | 33 | 0.1 to | 0.1 to | 47.4 to | 14.6 to | 57.1 to | 23.5 to |
| | | | | 99.9 | 99.9 | 85.4 | 52.6 | 76.5 | 42.9 |
| 305.4 | 68.9 | 65.7 | 34.3 | 0.1 to | 0.1 to | 43.3 to | 13.0 to | 54.4 to | 23.4 to |
| | | | | 99.9 | 99.9 | 87.0 | 56.7 | 76.6 | 45.6 |
| 375.8 | 78.9 | 64.6 | 35.4 | 0.1 to | 0.1 to | 38.0 to | 10.0 to | 51.2 to | 22.4 to |
| | | | | 99.9 | 99.9 | 90.0 | 62.0 | 77.6 | 48.8 |

### V. Azeotrope and Azeotrope-Like Compositions of 1, 1-difluoropropene (HFO-1252zc) and 2,3,3,3-tetrafluoropropene (HFO-1234yf)

The present disclosure provides a minimum-boiling, homogenous azeotrope or azeotrope-like composition comprising effective amounts of 1,1-difluoropropene (HFO-1252zc) and 2,3,3,3-tetrafluoropropene (HFO-1234yf). The present disclosure particularly provides a minimum-boiling, homogenous azeotrope or azeotrope-like composition consisting essentially of effective amounts of 1,1-difluoropropene (HFO-1252zc) and 2,3,3,3-tetrafluoropropene (HFO-1234yf). The present disclosure provides a minimum-boiling, homogenous azeotrope or azeotrope-like composition consisting of effective amounts of 1,1-difluoropropene (HFO-1252zc) and 2,3,3,3-tetrafluoropropene (HFO-1234yf).

The azeotrope or azeotrope-like composition may comprise from about 40.0 wt. % to about 58.7 wt. % of 1,1-difluoropropene (HFO-1252zc) and from about 41.3 wt. % to about 60.0 wt. % of 2,3,3,3-tetrafluoropropene (HFO-1234yf) at a temperature of about −28.5° C. to about 78.9° C. and a pressure of about 16.4 psia to about 365.8 psia.

The azeotrope or azeotrope-like composition may consist essentially of from about 40.0 wt. % to about 58.7 wt. % of 1,1-difluoropropene (HFO-1252zc) and from about 41.3 wt. % to about 60.0 wt. % of 2,3,3,3-tetrafluoropropene (HFO-1234yf) at a temperature of about −28.5° C. to about 78.9° C. and a pressure of about 16.4 psia to about 365.8 psia.

The azeotrope or azeotrope-like composition may consist of from about 40.0 wt. % to about 58.7 wt. % of 1,1-difluoropropene (HFO-1252zc) and from about 41.3 wt. % to about 60.0 wt. % of 2,3,3,3-tetrafluoropropene (HFO-1234yf) at a temperature of about −28.5° C. to about 78.9° C. and a pressure of about 16.4 psia to about 365.8 psia.

The azeotrope or azeotrope-like compositions may comprise of from about 0.1 wt. % to about 99.9 wt. % of 1,1-difluoropropene (HFO-1252zc) and from about 0.1 wt. % to about 99.9 wt. % of 2,3,3,3-tetrafluoropropene (HFO-1234yf), and more specifically, from about 0.1 wt. % to about 98.5 wt. % of 1,1-difluoropropene (HFO-1252zc) and from about 1.5 wt. % to about 99.9 wt. % of 2,3,3,3-tetrafluoropropene (HFO-1234yf), and still more specifically, about 40.0 wt. % of 1,1-difluoropropene (HFO-1252zc) and about 60.0 wt. % of 2,3,3,3-tetrafluoropropene (HFO-1234yf) at a pressure of about 365.8 psia.

The azeotrope or azeotrope-like compositions may consist essentially of from about 0.1 wt. % to about 99.9 wt. % of 1,1-difluoropropene (HFO-1252zc) and from about 0.1 wt. % to about 99.9 wt. % of 2,3,3,3-tetrafluoropropene (HFO-1234yf), and more specifically, from about 0.1 wt. % to about 98.5 wt. % of 1,1-difluoropropene (HFO-1252zc) and from about 1.5 wt. % to about 99.9 wt. % of 2,3,3,3-tetrafluoropropene (HFO-1234yf), and still more specifically, about 40.0 wt. % of 1,1-difluoropropene (HFO-1252zc) and about 60.0 wt. % of 2,3,3,3-tetrafluoropropene (HFO-1234yf) at a pressure of about 365.8 psia.

The azeotrope or azeotrope-like compositions may consist of from about 0.1 wt. % to about 99.9 wt. % of 1,1-difluoropropene (HFO-1252zc) and from about 0.1 wt. % to about 99.9 wt. % of 2,3,3,3-tetrafluoropropene (HFO-1234yf), and more specifically, from about 0.1 wt. % to about 98.5 wt. % of 1,1-difluoropropene (HFO-1252zc) and from about 1.5 wt. % to about 99.9 wt. % of 2,3,3,3-tetrafluoropropene (HFO-1234yf), and still more specifically, about 40.0 wt. % of 1,1-difluoropropene (HFO-1252zc) and about 60.0 wt. % of 2,3,3,3-tetrafluoropropene (HFO-1234yf) at a pressure of about 365.8 psia.

In other words, the compositions may comprise 1,1-difluoropropene (HFO-1252zc) in an amount of as much as about 99.9 wt. %, or about 98.5 wt. %, or about 40.0 wt. %, or as little as about 0.1 wt. %, or by any two of the foregoing values as endpoints, for example from about 0.1 wt. % to about 99.9 wt. %, from about 0.1 wt. % to about 98.5 wt. %, and/or about 40.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

In other words, the compositions may consist essentially of 1,1-difluoropropene (HFO-1252zc) in an amount of as much as about 99.9 wt. %, or about 98.5 wt. %, or about 40.0 wt. %, or as little as about 0.1 wt. %, or by any two of the foregoing values as endpoints, for example from about 0.1 wt. % to about 99.9 wt. %, from about 0.1 wt. % to about 98.5 wt. %, and/or about 40.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

In other words, the compositions may consist of 1,1-difluoropropene (HFO-1252zc) in an amount of as much as about 99.9 wt. %, or about 98.5 wt. %, or about 40.0 wt. %, or as little as about 0.1 wt. %, or by any two of the foregoing values as endpoints, for example from about 0.1 wt. % to about 99.9 wt. %, from about 0.1 wt. % to about 98.5 wt. %, and/or about 40.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

In other words, the compositions may comprise 2,3,3,3-tetrafluoropropene (HFO-1234yf) in an amount of as much as about 99.9 wt. %, or about 60.0 wt. %, or as little as about 1.5 wt. %, or about 0.1 wt. %, or by any two of the foregoing values as endpoints, for example from about 0.1 wt. % to about 99.9 wt. %, from about 1.5 wt. % to about 99.9 wt. %, and/or about 60.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

In other words, the compositions may consist essentially of 2,3,3,3-tetrafluoropropene (HFO-1234yf) in an amount of as much as about 99.9 wt. %, or about 60.0 wt. %, or as little as about 1.5 wt. %, or about 0.1 wt. %, or by any two of the foregoing values as endpoints, for example from about 0.1 wt. % to about 99.9 wt. %, from about 1.5 wt. % to about 99.9 wt. %, and/or about 60.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

In other words, the compositions may consist of 2,3,3,3-tetrafluoropropene (HFO-1234yf) in an amount of as much as about 99.9 wt. %, or about 60.0 wt. %, or as little as about 1.5 wt. %, or about 0.1 wt. %, or by any two of the foregoing values as endpoints, for example from about 0.1 wt. % to about 99.9 wt. %, from about 1.5 wt. % to about 99.9 wt. %, and/or about 60.0 wt. %, based on the total weight of the 1,1-difluoropropene (HFO-1252zc) and 2,3,3,3-tetrafluoropropene (HFO-1234yf) of the azeotrope or azeotrope-like composition at a pressure of about 365.8 psia.

The compositions may have azeotropic or azeotrope-like characteristics at a temperature of about 78.9° C., about 68.9° C., about 59.1° C., about 49.4° C., about 39.5° C., about 29.6° C., about 19.7° C., about 9.9° C., about 0.3° C., about −9.3° C., about −19.1° C., about −28.5° C., or within any range encompassed by any two of the foregoing values as endpoints, for example from about −28.5° C. to about 78.9° C.

The compositions may have azeotropic or azeotrope-like characteristics at a pressure of about 365.8 psia, about 297.3 psia, about 239.6 psia, about 191.6 psia, about 150.8 psia, about 116.3 psia, about 88.4 psia, about 66.1 psia, about 48.4 psia, about 34.8 psia, about 24.1 psia, about 16.4 psia, or within any range encompassed by any two of the foregoing values as endpoints, for example from about 16.4 psia to about 365.8 psia, from about 16.4 psia to about 239.6 psia, from about 24.1 psia to about 297.3 psia, from about 34.8 psia to about 365.8 psia, or from about 48.4 psia to about 365.8 psia.

Specifically, and as described in Table 4 below, the azeotrope or azeotrope-like composition of 1,1-difluoropropene (HFO-1252zc) and 2,3,3,3-tetrafluoropropene (HFO-1234yf) may correlate with pressure (psia) and saturation temperature (° C.).

In column (i) of Table 4 below, azeotrope-like composition ranges may depend as based upon the method used to determine such range. Specifically, (i) temperature glide is the difference between the saturated vapor temperature and the saturated liquid temperature at a fixed pressure in thermodynamic equilibrium. Consequently, an azeotrope composition may have a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This method was used to determine the relative compositions in column (i) of Table 1 below, which may be regarded as the broadest azeotrope-like composition range.

In column (ii) of Table 4 below, the relative volatility is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This may be regarded as an intermediate azeotrope-like composition range.

In column (iii) of Table 4 below a relative volatility of 1.05 is substantially close to 1.0 and therefore, compositions that satisfy such relative volatility are considered azeotrope-like. This may be regarded as the narrowest azeotrope-like composition range.

Column (1) of Table 4 below describes the azeotrope composition that, at a given pressure, the azeotrope composition boils at a constant characteristic temperature which is less than the lower boiling point component (minimum boiling azeotrope). At this characteristic temperature the same composition will exist in both the vapor and liquid phases. Therefore, the components of the azeotrope composition cannot be separated during a phase change and are regarded as the azeotrope composition. Such compositional values are presented in Column (1) of Table 4 below corresponding to each pressure and saturation temperature.

According, and in view of the foregoing, the azeotrope or azeotrope-like composition of 1,1-difluoropropene (HFO-1252zc) and 2,3,3,3-tetrafluoropropene (HFO-1234yf) may comprise any of the values as described in each of columns (1), (i), (ii) or (iii) in each row of Table 4 below.

The azeotrope or azeotrope-like composition of 1,1-difluoropropene (HFO-1252zc) and 2,3,3,3-tetrafluoropropene (HFO-1234yf) may consist essentially of any of the values as described in each of columns (1), (i), (ii) or (iii) in each row of Table 4 below.

The azeotrope or azeotrope-like composition of 1,1-difluoropropene (HFO-1252zc) and 2,3,3,3-tetrafluoropropene (HFO-1234yf) may consist of any of the values described in each of columns (1), (i), (ii) or (iii) in each row of Table 4 below.

TABLE 4
Azeotrope Composition and (2) Azeotrope-like composition ranges of 1,1-difluoropropene
(HFO-1252zc) and 2,3,3,3-tetrafluoropropene (HFO-1234yf):

| | | | | (2) Azeotropic-Like Composition Range | | | | | |
|---|---|---|---|---|---|---|---|---|---|
| | | (1) Azeotropic | | (i) | | (ii) | | (iii) | |
| | | Composition | | Glide <0.5° C. | | Rel. Vol. <1.1 | | Rel. Vol. <1.05 | |
| Sat. | Sat. | Wt. % | Wt. % | Wt. % | Wt. % | Wt. % | Wt. % | Wt. % | Wt. % |
| Pres. | Temp. | HFO- | HFO- | HFO- | HFO- | HFO- | HFO- | HFO- | HFO- |
| (psia) | (° C.) | 1252zc | 1234yf | 1252zc | 1234yf | 1252zc | 1234yf | 1252zc | 1234yf |
| 16.4 | −28.5 | 58.7 | 41.3 | 0.1 to | 0.1 to | 25.5 to | 0.1 to | 40.8 to | 21.1 to |
| | | | | 99.9 | 99.9 | 99.9 | 74.5 | 78.9 | 59.2 |
| 24.1 | −19.1 | 56.1 | 43.9 | 0.1 to | 0.1 to | 21.4 to | 0.1 to | 37.4 to | 22.5 to |
| | | | | 99.9 | 99.9 | 99.9 | 78.6 | 77.5 | 62.6 |
| 34.8 | −9.3 | 53.8 | 46.2 | 0.1 to | 0.1 to | 17.2 to | 0.1 to | 34.0 to | 23.5 to |
| | | | | 99.9 | 99.9 | 99.9 | 82.8 | 76.5 | 66.0 |
| 48.4 | 0.3 | 51.8 | 48.2 | 0.1 to | 0.1 to | 13.1 to | 0.1 to | 30.8 to | 24.0 to |
| | | | | 99.9 | 99.9 | 99.9 | 86.9 | 76.0 | 69.2 |
| 66.1 | 9.9 | 50 | 50 | 0.1 to | 0.1 to | 9.0 to | 0.1 to | 27.7 to | 24.0 to |
| | | | | 99.9 | 99.9 | 99.9 | 91.0 | 76.0 | 72.3 |
| 88.4 | 19.7 | 48.4 | 51.6 | 0.1 to | 0.1 to | 4.6 to | 0.1 to | 24.6 to | 23.6 to |
| | | | | 99.9 | 99.9 | 99.9 | 95.4 | 76.4 | 75.4 |
| 116.3 | 29.6 | 46.9 | 53.1 | 0.1 to | 0.1 to | 0.1 to | 0.1 to | 21.3 to | 22.7 to |
| | | | | 99.9 | 99.9 | 99.9 | 99.9 | 77.3 | 78.7 |
| 150.8 | 39.5 | 45.5 | 54.5 | 0.1 to | 0.1 to | 0.1 to | 0.1 to | 17.6 to | 21.1 to |
| | | | | 99.9 | 99.9 | 99.9 | 99.9 | 78.9 | 82.4 |
| 191.6 | 49.4 | 44.2 | 55.8 | 0.1 to | 0.1 to | 0.1 to | 0.1 to | 13.5 to | 18.7 to |
| | | | | 99.9 | 99.9 | 99.9 | 99.9 | 81.3 | 86.5 |
| 239.6 | 59.1 | 42.9 | 57.1 | 0.1 to | 0.1 to | 0.1 to | 0.1 to | 8.6 to | 15.4 to |
| | | | | 99.9 | 99.9 | 99.9 | 99.9 | 84.6 | 91.4 |
| 297.3 | 68.9 | 41.5 | 58.5 | 0.1 to | 0.1 to | 0.1 to | 0.1 to | 1.8 to | 10.2 to |
| | | | | 99.9 | 99.9 | 99.9 | 99.9 | 89.8 | 98.2 |
| 365.8 | 78.9 | 40 | 60 | 0.1 to | 0.1 to | 0.1 to | 0.1 to | 0.1 to | 1.5 to |
| | | | | 99.9 | 99.9 | 99.9 | 99.9 | 98.5 | 99.9 |

### VII. Applications

As described in detail below, the present azeotrope or azeotrope-like compositions may be used as refrigerants in heat transfer systems, including each of the various heat transfer systems described below.

The preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle.

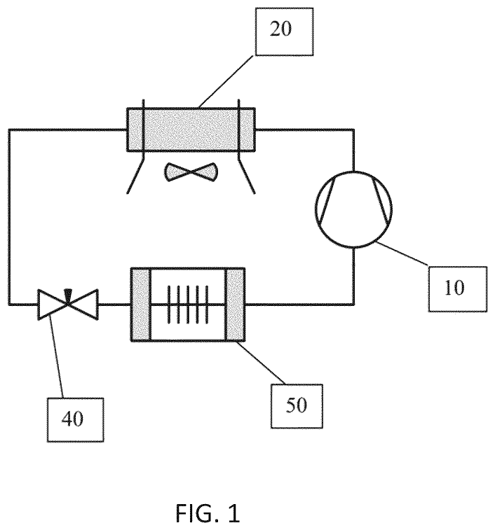

An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature pressure, which in turn is then provided to evaporator 50. In evaporator 50 the liquid refrigerant absorbs heat from the body or fluid being cooled, thus producing a refrigerant vapor which is then provided to the suction line of the compressor.

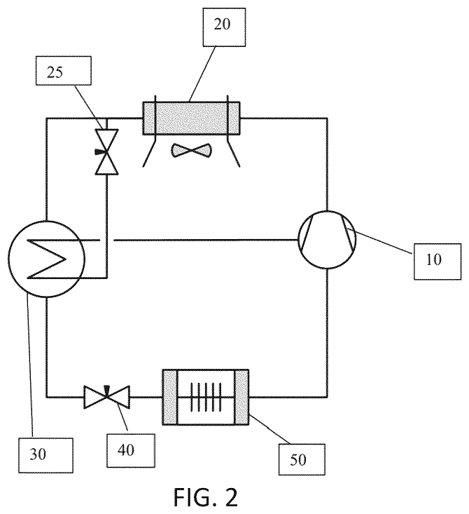

The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

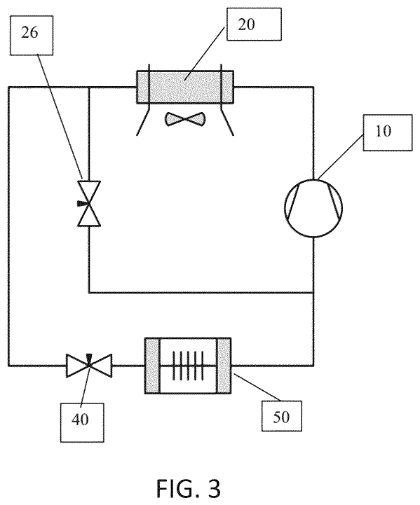

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

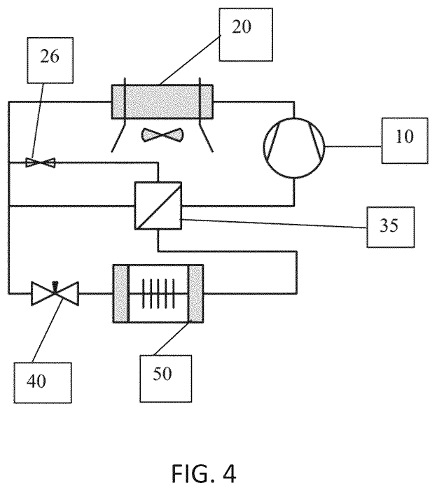

The refrigeration system illustrated in FIG. 4 is the same as described above in connection with FIG. 1 except that it includes a liquid line/suction line heat exchanger 35. The valve 26 diverts a portion of the of the refrigerant flow at the condenser outlet to the liquid line/suction line heat exchanger, where heat is transferred from the liquid refrigerant to the refrigerant vapor leaving evaporator 50.

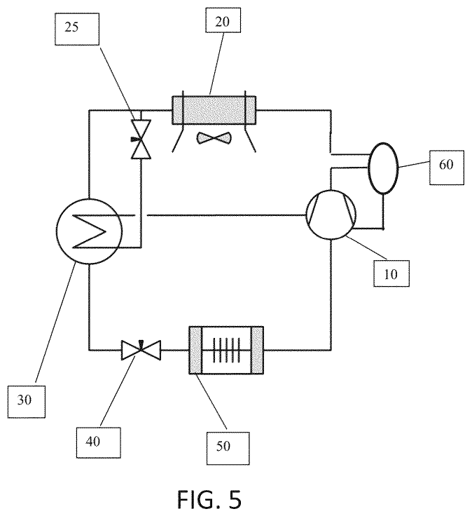

The refrigeration system illustrated in FIG. 5 is the same as described above in connection with FIG. 1 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

It will be appreciated by those skilled in the art that the different equipment/configuration options shown separately in each of FIGS. 2-5 can be combined and used together as deemed advantageous for any application.

Certain specific heat transfer systems are described below, wherein each may use, as a refrigerant, each of the present azeotrope or azeotrope-like compositions.

In each of the heat transfer systems described below, lubricants may optionally be used which are miscible with the azeotrope or azeotrope-like compositions throughout the working temperature range of the refrigerants. Suitable lubricants include polyol ether (POE), polyvinyl ether (PVE), and/or polyalphaolefin (PAO) lubricants.

### A. Residential Air-Conditioning System (Cooling)

A residential air-conditioning system used to supply cool air (about 12° C.) to buildings in the summer is tested. Typical system types include ducted split, ductless split, window, and portable air-conditioning systems. The system usually has an air-to-refrigerant evaporator (indoor coil), a compressor, an air-to-refrigerant condenser (outdoor coil), and an expansion device. The evaporator and condenser are commonly finned tube or microchannel heat exchangers. The compressor is commonly reciprocating, rotary (rolling-piston or rotary vane) or scroll compressor. The expansion device is commonly a capillary tube or a thermal or electronic expansion valve. The refrigerant evaporating temperature is commonly in the range of about 0° C. to about 10° C., while the condensing temperature is in the range of about 40° C. to about 70° C.

### B. Residential Air-Conditioning System (Heating)

Residential heat pump systems are used to supply warm air (21° C.) to buildings in the winter and are typically configured the same as residential air-conditioning systems. However, when such systems operate in the heat pump mode, the refrigerant flow is reversed such that the indoor coil becomes a condenser, and the outdoor coil becomes an evaporator. Typical system types are ducted split and ductless split heat pump systems. The evaporator and condenser are typically finned tube or microchannel heat exchangers, and the compressor is typically a reciprocating or rotary (rolling-piston or rotary vane) or scroll compressor. The expansion device is commonly a capillary tube or a thermal or electronic expansion valve. Commonly the refrigerant evaporating temperature is in the range of about −30 to about 5° C., while the condensing temperature range is about 35 to about 50° C.

### C. Commercial Air Conditioning (Chillers)

Commercial air-conditioning systems (chillers) are used to supply chilled water (about 7° C.) to large buildings such as offices, hospitals, etc. Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin or microchannel condenser to exchange heat with ambient air, and a thermal or electronic expansion valve. The water-cooled system usually has a shell-and-tube evaporator to supply chilled water, a reciprocating or scroll compressor, a shell-and-tube condenser to exchange heat with water from a cooling tower or lake, sea, and other natural recourses, and a thermal or electronic expansion valve. The refrigerant evaporating temperature is in the range of about 0 to about 10° C., while the condensing temperature is in the range of about 40° C. to about 70° C.

### D. Residential Air-to-Water Heat Pump Systems (Hydronic)

Residential air-to-water heat pump hydronic systems, such as mono-block heat pumps and chillers, are typically used to supply hot water (about 55° C.) to buildings for floor heating or similar applications in the winter. The hydronic system usually has a finned or microchannel evaporator to exchange heat with ambient air, a reciprocating, rotary, or scroll compressor, a plate, tube-in-tube, or shell-and-tube condenser to heat the water, and a thermal or electronic expansion valve. The refrigerant evaporating temperature is typically in the range of about −30 to about 5° C., while the condensing temperature is typically in the range of about 50 to about 90° C.

This application covers cold climate air to water heat pumps that use the external air as a heat source for its evaporator and heats a secondary fluid, such as water, another refrigerant or brine, which is then used to heat the building. To evaluate its cold climate performance an evaporating temperature of −30° C. was selected and the condensing temperature may vary between 35° C. and 70° C., but a temperature of 60° C. was selected.

### E. Water/Brine-to-Air Heat Pump Systems

This application covers mild climate water/brine to air heat pump systems, such as ground-source heat pumps or any heat pump system that uses a secondary fluid in a liquid or two-phase state as a heat source for its evaporator and heats the indoor airflow through its condenser. Commonly the refrigerant evaporating temperature is in the range of about −5° C. to about 5° C., while the condensing temperature range is about 30 to about 60° C.

### F. Water/Brine to Water Heat Pumps

This application covers mild climate water/brine to water heat pumps, such as ground-source heat pumps or any heat pump systems that use a secondary fluid in a liquid or two-phase state as a heat source for its evaporator and heats a secondary fluid, such as water, another refrigerant or brine, which is then used to heat the building. Commonly the refrigerant evaporating temperature is in the range of about −5° C. to about 5° C., while the condensing temperature range is about 35 to about 70° C.

### G. Domestic Hot Water Heat Pumps

This application covers domestic hot water heat pumps which may use outdoor or indoor air as a heat source or use water as a heat source, such as sewage, to heat domestic hot water to be used in a building. Commonly the refrigerant evaporating temperature is about 10° C., while the condensing temperature range is about 55 to about 80° C.

### H. Tumble Dryer and Other Small Appliance Heat Pumps

Mobile heat pumps systems are used to are used to supply warm air (about 21° C.) to the passenger compartment of an automobile in the winter. The system usually has an air-to-refrigerant evaporator to exchange heat with the ambient air, a reciprocating, scroll, or screw compressor, an air-to-refrigerant condenser to exchange heat with the passenger compartment air, and a thermal or electronic expansion valve.

This application covers tumble dryers and other small appliances, such as dishwashers and portable heat pumps which use outdoor or indoor air as a heat source, or use water as a heat source, such as sewage, to provide heat for small appliance applications. Commonly the refrigerant evaporating temperature is about 15° C., while the condensing temperature range is about 45 to about 80° C.

### I. Medium-Temperature Refrigeration System Performance

Medium temperature refrigeration systems are used to chill food or beverages such as in a refrigerator and bottle cooler. The system usually has an air-to-refrigerant evaporator to chill the food or beverage, a reciprocating, scroll, or screw compressor, an air-to-refrigerant condenser to exchange heat with the ambient air, and a thermal or electronic expansion valve. The refrigerant evaporating temperature is in the range of about −12° C. to about 0° C., while the condensing temperature is in the range of about 20° C. to about 70° C.

### J. Low-Temperature Refrigeration System Performance

Low-temperature refrigeration systems are used to freeze food such as in an ice cream machine and a freezer. The system usually has an air-to-refrigerant evaporator, a reciprocating, scroll, or screw compressor, an air-to-refrigerant condenser to exchange heat with the ambient air, and a thermal or electronic expansion valve. The refrigerant evaporating temperature is in the range of about −40° C. to about −12° C., while the condensing temperature is in the range of about 20 to about 70° C.

### K. Mobile Heat Pump Performance (Heating Mode)

Mobile heat pumps systems are used to are used to supply warm air (about 21° C.) to the passenger compartment of an automobile in the winter. The system usually has an air-to-refrigerant evaporator to exchange heat with the ambient air, a reciprocating, scroll, or screw compressor, an air-to-refrigerant condenser to exchange heat with the passenger compartment air, and a thermal or electronic expansion valve.

### EXAMPLES

### Example 1: Measurement and Characterization of Azeotrope and Azeotrope-Like Compositions of Difluoromethane (HFC-32) and 1,1-difluoropropene (HFO-1252zc)

A set of volume calibrated PTx cells were used to measure azeotrope and azeotrope-like compositions of difluoromethane (HFC-32) and 1,1-difluoropropene (HFO-1252zc). Mixtures of HFC-32 and HFO-1252zc were gravimetrically prepared into evacuated PTx cells; two cells were reserved for measuring each pure component. Once prepared, each of up to eight cells of differing compositions were inserted into a thermostated chamber. In the chamber, each cell was attached to an instrumentation manifold equipped with calibrated pressure transducers and resistance temperature detectors (RTD); this provided a means to measure and record the total saturation pressure of each cell's contents at its local temperature.

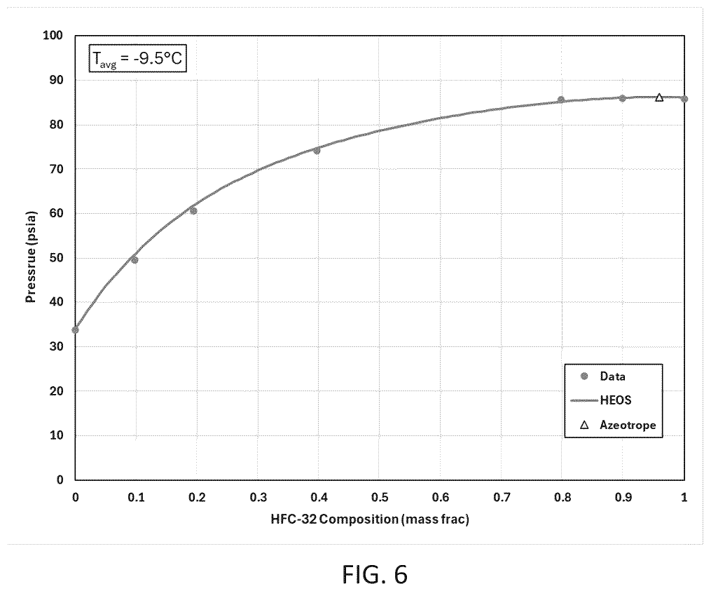

To establish equilibrium at a target temperature, the set point of the chamber was adjusted, yielding an average temperature (T_{avg}) of −9.5° C. across all of the PTx cells. Once at equilibrium, recognized as when temperature and pressures of each cell remain stable for several hours, the local temperature and saturation pressures of each cell were recorded. From these pressure-temperature-composition data, the binary interaction parameters of HFC-32 and HFO-1252zc for the Helmholtz Energy Equation of State (HEOS) were identified. As indicated by the maximum pressure shown in FIG. 6, a homogeneous, minimum boiling azeotrope composition of about 95.9 wt. % HFC-32 and about 4.1 wt. % HFO-1252zc was formed based on the data presented in Table 5

TABLE 5
PTx Study of HFC-32 and HFO-1252zc at an average
temperature of −9.5° C. Maximum pressure observed
between 79.8 wt % HFC-32 and 100.0 wt % HFC-32,
azeotrope formed at about 95.9 wt % HFC-32.

| HFC-32 | HFO-1252zc | |
|---|---|---|
| Composition | Composition | Pressure |
| (wt %) | (wt %) | (psia) |
| 100.0 | 0.0 | 85.7 |
| 89.9 | 10.1 | 85.8 |
| 79.8 | 20.2 | 85.6 |
| 39.7 | 60.3 | 74.1 |
| 19.4 | 80.6 | 60.7 |
| 9.7 | 90.3 | 49.6 |
| 0.0 | 100.0 | 33.7 |

### Example 2: Azeotrope Locus

The procedure of Example 1 was repeated for each of the temperatures indicated in Table 6 below to generate the azeotropic and azeotrope-like compositional ranges.

TABLE 6
Azeotrope Locus

| | | | Azeotropic-Like Composition Range | | | |
|---|---|---|---|---|---|---|
| | | Azeotropic | Glide <0.5° C. | | Rel. | Rel. |
| Saturation | Saturation | Composition | Wt. % | | Vol. <1.1 | Vol. <1.05 |
| Pressure | Temperature | Wt. % | HFO- | Wt. % | Wt. % | Wt. % |
| (psia) | (° C.) | HFC-32 | 1252zc | HFC-32 | HFC-32 | HFC-32 |
| 42.4 | −28.5 | 91.4 | 8.6 | 74.3 to 99.9 | 85.8 to 96.9 | 88.5 to 94.1 |
| 60.9 | −19.2 | 93.6 | 6.4 | 75.3 to 99.9 | 87.5 to 99.6 | 90.5 to 96.6 |
| 86.2 | −9.5 | 95.9 | 4.1 | 76.2 to 99.9 | 89.2 to 99.9 | 92.4 to 99.2 |
| 118.5 | 0.2 | 98.1 | 1.9 | 77.0 to 99.9 | 90.8 to 99.9 | 94.9 to 99.9 |
| 159.7 | 9.8 | — | — | 77.8 to 99.9 | 92.3 to 99.9 | 96.2 to 99.9 |
| 211.6 | 19.6 | — | — | 78.4 to 99.9 | 93.6 to 99.9 | 98.0 to 99.9 |
| 275.8 | 29.5 | — | — | 78.8 to 99.9 | 94.5 to 99.9 | 99.5 to 99.9 |
| 354.4 | 39.4 | — | — | 78.9 to 99.9 | 95.2 to 99.9 | — |
| 447.5 | 49.2 | — | — | 78.6 to 99.9 | 95.0 to 99.9 | — |

In view of the above data, temperature glide and relative volatility were applied to determine the azeotrope and azeotrope-like compositions.

The temperature glide and relative volatility of a mixture may be derived from thermodynamic measurements, such as those collected via PTx, subject to material balance and thermodynamic constraints. Several methods for deriving temperature glide from thermodynamic measurements are described in Sandler, S. I. (2006). Chapter 10: Vapor-Liquid Equilibrium in Mixtures. In Chemical, Biochemical, and Engineering Thermodynamics (4th ed., pp. 489-574) which includes constraining thermodynamic consistency through the fundamental Gibbs-Duhem relationship and resolving the vapor phase composition, from the measurements, through combined mass balance and equilibrium criteria (frequently referred to as the Rachford-Rice equation or algorithm). Through this derivation, the relationship between equilibrium compositions, temperatures, and pressures are established, permitting temperature glide and relative volatility to be evaluated.

For a given composition, the temperature glide, by definition, is the difference between the saturated vapor temperature and the saturated liquid temperature at a fixed pressure in thermodynamic equilibrium. Consequently, an azeotrope composition has a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This is the broad azeotrope-like range.

The relative volatility, by definition, is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This is the intermediate azeotrope-like range.

Additionally, it has been identified that a relative volatility of 1.05 is substantially close to 1.0 and therefore compositions that satisfy such relative volatility are considered azeotrope-like. This is the narrow azeotrope-like range.

### Example 3: Measurement and Characterization of Azeotrope and Azeotrope-Like Compositions of 1,1-difluoropropene (HFO-1252zc) and 1,1,1,2-tetrafluoroethane (HFC-134a)

A set of volume calibrated PTx cells were used to measure azeotrope and azeotrope-like compositions of 1,1-difluoropropene (HFO-1252zc) and 1,1,1,2-tetrafluoroethane (HFC-134a). Mixtures of HFO-1252zc and HFC-134a were gravimetrically prepared into evacuated PTx cells; two cells were reserved for measuring each pure component. Once prepared, each of up to eight cells of differing compositions were inserted into a thermostated chamber. In the chamber, each cell was attached to an instrumentation manifold equipped with calibrated pressure transducers and resistance temperature detectors (RTD); this provided a means to measure and record the total saturation pressure of each cell's contents at its local temperature.

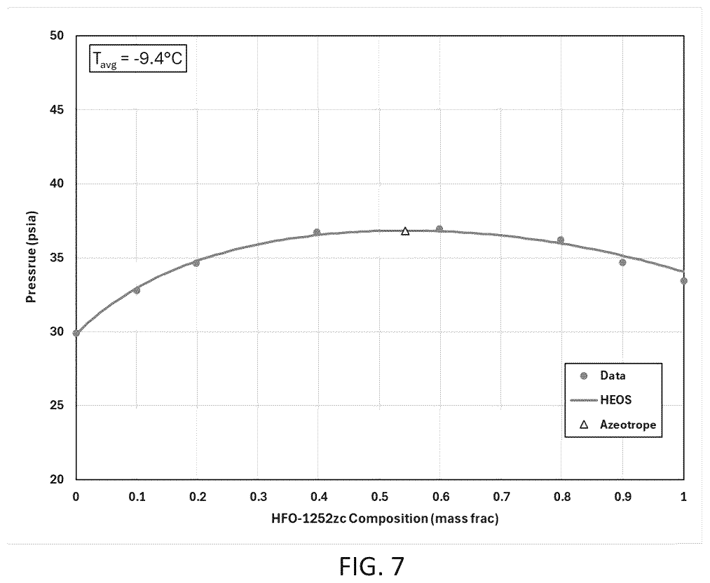

To establish equilibrium at a target temperature, the set point of the chamber was adjusted, yielding an average temperature (T_{avg}) of −9.4° C. across all of the PTx cells. Once at equilibrium, recognized as when temperature and pressures of each cell remain stable for several hours, the local temperature and saturation pressures of each cell were recorded. From these pressure-temperature-composition data, the binary interaction parameters of HFO-1252zc and HFC-134a for the Helmholtz Energy Equation of State (HEOS) were identified. As indicated by the maximum pressure shown in FIG. 7, a homogeneous, minimum boiling azeotrope composition of about 54.2 wt. % HFO-1252zc and about 45.8 wt. % HFC-134a was formed based on the data presented in Table 7

TABLE 7
PTx Study of HFO-1252zc and HFC-134a at an average
temperature of −9.4° C. Maximum pressure observed
between 39.6 wt % HFO-1252zc and 79.7 wt % HFO-1252zc,
azeotrope formed at about 54.2 wt % HFO-1252zc.

| HFO-1252zc | HFC-134a | |
|---|---|---|
| Composition | Composition | Pressure |
| (wt %) | (wt %) | (psia) |
| 100.0 | 0.0 | 33.4 |
| 89.9 | 10.1 | 34.7 |
| 79.7 | 20.3 | 36.2 |
| 59.8 | 40.2 | 36.9 |
| 39.6 | 60.4 | 36.7 |
| 19.8 | 80.2 | 34.7 |
| 10.0 | 90.0 | 32.8 |
| 0.0 | 100.0 | 29.9 |

### Example 4: Azeotrope Locus

The procedure of Example 3 was repeated for each of the temperatures indicated in Table 8 below to generate the azeotropic and azeotrope-like compositional ranges.

TABLE 8
Azeotrope Locus

| | | | | Azeotropic-Like Composition Range | | |
|---|---|---|---|---|---|---|
| | | Azeotropic | | | Rel. | Rel. |
| | | Composition | | Glide <0.5° C. | Vol. <1.1 | Vol. <1.05 |
| Saturation | Saturation | Wt. % | Wt. % | Wt. % | Wt. % | Wt. % |
| Pressure | Temperature | HFO- | HFC- | HFO- | HFO- | HFO- |
| (psia) | (° C.) | 1252zc | 134a | 1252zc | 1252zc | 1252zc |
| 16.6 | −29.4 | 59.6 | 40.4 | 36.1 to 99.9 | 50.8 to 69.1 | 55.0 to 64.3 |
| 25.4 | −19.1 | 56.7 | 43.3 | 32.7 to 99.9 | 47.4 to 66.7 | 51.9 to 61.7 |
| 36.9 | −9.4 | 54.2 | 45.8 | 29.6 to 99.9 | 44.4 to 64.7 | 49.1 to 59.4 |
| 51.7 | 0.3 | 51.9 | 48.1 | 26.3 to 99.9 | 41.6 to 63.0 | 46.5 to 57.4 |
| 70.8 | 9.9 | 49.6 | 50.4 | 22.8 to 99.9 | 38.8 to 61.5 | 43.9 to 55.5 |
| 95.1 | 19.6 | 47.5 | 52.5 | 18.6 to 99.9 | 36.0 to 60.2 | 41.5 to 53.8 |
| 125.6 | 29.5 | 45.5 | 54.5 | 0.1 to 99.9 | 33.1 to 59.2 | 39.0 to 52.2 |
| 163.4 | 39.4 | 43.6 | 56.4 | 0.1 to 99.9 | 30.2 to 58.4 | 36.6 to 50.9 |
| 208.5 | 49.3 | 41.8 | 58.2 | 0.1 to 99.9 | 27.2 to 58.1 | 34.1 to 49.8 |
| 261.8 | 59.0 | 40.1 | 59.9 | 0.1 to 99.9 | 24.0 to 58.5 | 31.6 to 49.1 |
| 326.2 | 68.9 | 38.5 | 61.5 | 0.1 to 99.9 | 20.1 to 59.8 | 28.8 to 48.9 |
| 403.5 | 78.9 | 36.9 | 63.1 | 0.1 to 99.9 | 15.0 to 63.5 | 25.3 to 49.7 |

In view of the above data, temperature glide and relative volatility were applied to determine the azeotrope and azeotrope-like compositions.

The temperature glide and relative volatility of a mixture may be derived from thermodynamic measurements, such as those collected via PTx, subject to material balance and thermodynamic constraints. Several methods for deriving temperature glide from thermodynamic measurements are described in Sandler, S. I. (2006). Chapter 10: Vapor-Liquid Equilibrium in Mixtures. In Chemical, Biochemical, and Engineering Thermodynamics (4th ed., pp. 489-574) which includes constraining thermodynamic consistency through the fundamental Gibbs-Duhem relationship and resolving the vapor phase composition, from the measurements, through combined mass balance and equilibrium criteria (frequently referred to as the Rachford-Rice equation or algorithm). Through this derivation, the relationship between equilibrium compositions, temperatures, and pressures are established, permitting temperature glide and relative volatility to be evaluated.

For a given composition, the temperature glide, by definition, is the difference between the saturated vapor temperature and the saturated liquid temperature at a fixed pressure in thermodynamic equilibrium. Consequently, an azeotrope composition has a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This is the broad azeotrope-like range.

The relative volatility, by definition, is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This is the intermediate azeotrope-like range.

Additionally, it has been identified that a relative volatility of 1.05 is substantially close to 1.0 and therefore compositions that satisfy such relative volatility are considered azeotrope-like. This is the narrow azeotrope-like range.

### Example 5: Measurement and Characterization of Azeotrope and Azeotrope-Like Compositions of 1,1-difluoropropene (HFO-1252zc) and 1,1-difluoroethane (HFC-152a)

A set of volume calibrated PTx cells were used to measure azeotrope and azeotrope-like compositions of 1,1-difluoropropene (HFO-1252zc) and 1,1-difluoroethane (HFC-152a). Mixtures of HFO-1252zc and HFC-152a were gravimetrically prepared into evacuated PTx cells; two cells were reserved for measuring each pure component. Once prepared, each of up to eight cells of differing compositions were inserted into a thermostated chamber. In the chamber, each cell was attached to an instrumentation manifold equipped with calibrated pressure transducers and resistance temperature detectors (RTD); this provided a means to measure and record the total saturation pressure of each cell's contents at its local temperature.

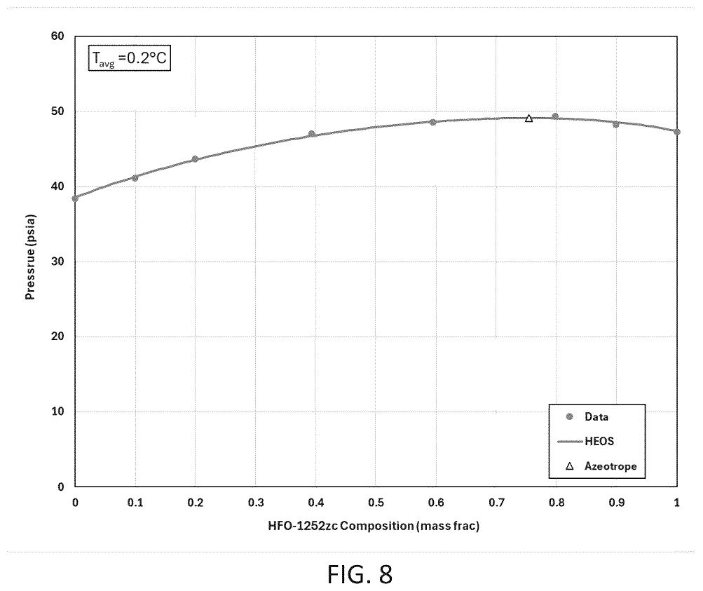

To establish equilibrium at a target temperature, the set point of the chamber was adjusted, yielding an average temperature (T_{avg}) of 0.2° C. across all of the PTx cells. Once at equilibrium, recognized as when temperature and pressures of each cell remain stable for several hours, the local temperature and saturation pressures of each cell were recorded. From these pressure-temperature-composition data, the binary interaction parameters of HFO-1252zc and HFC-152a for the Helmholtz Energy Equation of State (HEOS) were identified. As indicated by the maximum pressure shown in FIG. 8, a homogeneous, minimum boiling azeotrope composition of about 75.4 wt. % HFO-1252zc and about 24.6 wt. % HFC-152a was formed based on the data presented in Table 9.

TABLE 9
PTx Study of HFO-1252zc and HFC-152a at an average
temperature of 0.2° C. Maximum pressure observed
between 59.5 wt % HFO-1252zc and 89.8 wt % HFO-1252zc,
azeotrope formed at about 75.4 wt % HFO-1252zc.

| HFO-1252zc | HFC-152a | |
|---|---|---|
| Composition | Composition | Pressure |
| (wt %) | (wt %) | (psia) |
| 100.0 | 0.0 | 47.3 |
| 89.8 | 10.2 | 48.2 |
| 79.7 | 20.3 | 49.3 |
| 59.5 | 40.5 | 48.5 |
| 39.3 | 60.7 | 47.1 |
| 19.9 | 80.1 | 43.7 |
| 10.0 | 90.0 | 41.1 |
| 0.0 | 100.0 | 38.4 |

### Example 6: Azeotrope Locus

The procedure of Example 5 was repeated for each of the temperatures indicated in Table 10 below to generate the azeotropic and azeotrope-like compositional ranges.

TABLE 10
Azeotrope Locus

| | | | Azeotropic-Like Composition Range | | | |
|---|---|---|---|---|---|---|
| | | Azeotropic | | | Rel. | Rel. |
| | | Composition | Glide <0.5° C. | | Vol. <1.1 | Vol. <1.05 |
| Saturation | Saturation | Wt. % | Wt. % | Wt. % | Wt. % | Wt. % |
| Pressure | Temperature | HFO- | HFC- | HFO- | HFO- | HFO- |
| (psia) | (° C.) | 1252zc | 152a | 1252zc | 1252zc | 1252zc |
| 16.0 | −29.4 | 80.1 | 19.9 | 55.4 to 99.9 | 71.5 to 88.3 | 75.7 to 84.3 |
| 24.3 | −19.2 | 78.4 | 21.6 | 52.8 to 99.9 | 69.1 to 87.3 | 73.7 to 83.0 |
| 35.2 | −9.4 | 76.9 | 23.1 | 50.3 to 99.9 | 66.8 to 86.5 | 71.7 to 81.8 |
| 49.3 | 0.2 | 75.4 | 24.6 | 47.6 to 99.9 | 64.5 to 85.8 | 69.8 to 80.7 |
| 67.1 | 9.9 | 73.9 | 26.1 | 44.8 to 99.9 | 62.1 to 85.2 | 67.9 to 79.7 |
| 90.0 | 19.6 | 72.5 | 27.5 | 41.7 to 99.9 | 59.5 to 84.8 | 65.9 to 78.8 |
| 118.6 | 29.5 | 71.0 | 29.0 | 38.2 to 99.9 | 56.9 to 84.5 | 63.9 to 77.9 |
| 153.8 | 39.4 | 69.6 | 30.4 | 33.9 to 99.9 | 54.0 to 84.4 | 61.7 to 77.2 |
| 195.9 | 49.3 | 68.3 | 31.7 | 27.9 to 99.9 | 50.9 to 84.7 | 59.5 to 76.7 |
| 245.3 | 59.0 | 67.0 | 33.0 | 0.1 to 99.9 | 47.4 to 85.4 | 57.1 to 76.5 |
| 305.4 | 68.9 | 65.7 | 34.3 | 0.1 to 99.9 | 43.3 to 87.0 | 54.4 to 76.6 |
| 375.8 | 78.9 | 64.6 | 35.4 | 0.1 to 99.9 | 38.0 to 90.0 | 51.2 to 77.6 |

In view of the above data, temperature glide and relative volatility were applied to determine the azeotrope and azeotrope-like compositions.

The temperature glide and relative volatility of a mixture may be derived from thermodynamic measurements, such as those collected via PTx, subject to material balance and thermodynamic constraints. Several methods for deriving temperature glide from thermodynamic measurements are described in Sandier, S. I. (2006). Chapter 10: Vapor-Liquid Equilibrium in Mixtures. In Chemical, Biochemical, and Engineering Thermodynamics (4th ed., pp. 489-574) which includes constraining thermodynamic consistency through the fundamental Gibbs-Duhem relationship and resolving the vapor phase composition, from the measurements, through combined mass balance and equilibrium criteria (frequently referred to as the Rachford-Rice equation or algorithm). Through this derivation, the relationship between equilibrium compositions, temperatures, and pressures are established, permitting temperature glide and relative volatility to be evaluated.

For a given composition, the temperature glide, by definition, is the difference between the saturated vapor temperature and the saturated liquid temperature at a fixed pressure in thermodynamic equilibrium. Consequently, an azeotrope composition has a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This is the broad azeotrope-like range.

The relative volatility, by definition, is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This is the intermediate azeotrope-like range.

Additionally, it has been identified that a relative volatility of 1.05 is substantially close to 1.0 and therefore compositions that satisfy such relative volatility are considered azeotrope-like. This is the narrow azeotrope-like range.

### Example 7: Measurement and Characterization of Azeotrope and Azeotrope-Like Compositions of 1,1-difluoropropene (HFO-1252zc) and 2,3,3,3-tetrafluoropropene (HFO-1234yf)

A set of volume calibrated PTx cells were used to measure azeotrope and azeotrope-like compositions of 1,1-difluoropropene (HFO-1252zc) and 2,3,3,3-tetrafluoropropene (HFO-1234yf). Mixtures of HFO-1252zc and HFO-1234yf were gravimetrically prepared into evacuated PTx cells; two cells were reserved for measuring each pure component. Once prepared, each of up to eight cells of differing compositions were inserted into a thermostated chamber. In the chamber, each cell was attached to an instrumentation manifold equipped with calibrated pressure transducers and resistance temperature detectors (RTD); this provided a means to measure and record the total saturation pressure of each cell's contents at its local temperature.

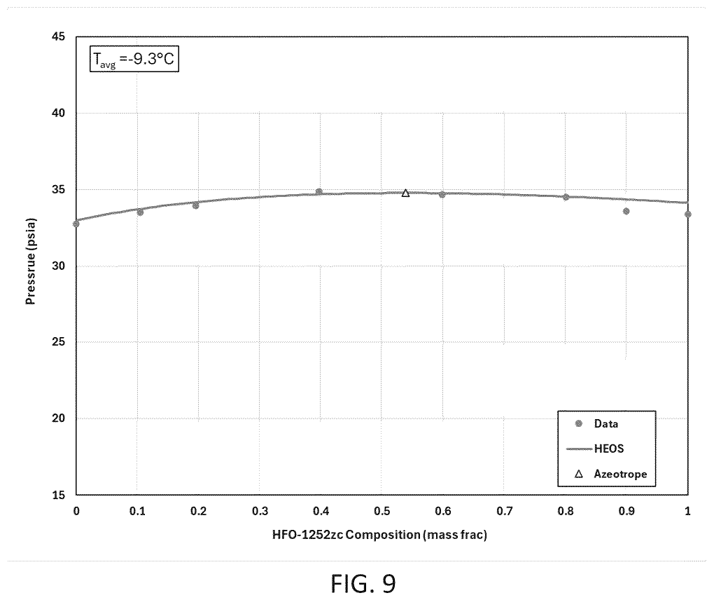

To establish equilibrium at a target temperature, the set point of the chamber was adjusted, yielding an average temperature (T_{avg}) of −9.3° C. across all of the PTx cells. Once at equilibrium, recognized as when temperature and pressures of each cell remain stable for several hours, the local temperature and saturation pressures of each cell were recorded. From these pressure-temperature-composition data, the binary interaction parameters of HFO-1252zc and HFO-1234yf for the Helmholtz Energy Equation of State (HEOS) were identified. As indicated by the maximum pressure shown in FIG. 9, a homogeneous, minimum boiling azeotrope composition of about 53.8 wt. % HFO-1252zc and about 46.2 wt. % HFO-1234yf was formed based on the data presented in Table 11.

TABLE 11
PTx Study of HFO-1252zc and HFO-1234yf at an average
temperature of −9.3° C. Maximum pressure observed
between 19.6 wt % HFO-1252zc and 59.8 wt % HFO-1252zc,
azeotrope formed at about 53.8 wt % HFO-1252zc.

| HFO-1252zc | HFO-1234yf | |
|---|---|---|
| Composition | Composition | Pressure |
| (wt %) | (wt %) | (psia) |
| 100.0 | 0.0 | 33.4 |
| 89.9 | 10.1 | 33.6 |
| 80.1 | 19.9 | 34.5 |
| 59.8 | 40.2 | 34.7 |
| 39.6 | 60.4 | 34.8 |
| 19.6 | 80.4 | 34.0 |
| 10.4 | 89.6 | 33.5 |
| 0.0 | 100.0 | 32.8 |

### Example 8: Azeotrope Locus

The procedure of Example 7 was repeated for each of the temperatures indicated in Table 12 below to generate the azeotropic and azeotrope-like compositional ranges.

TABLE 12
Azeotrope Locus

| | | | | Azeotropic-Like Composition Range | | |
|---|---|---|---|---|---|---|
| | | Azeotropic | | | Rel. | Rel. |
| | | Composition | | Glide <0.5° C. | Vol. <1.1 | Vol. <1.05 |
| Saturation | Saturation | Wt. % | Wt. % | Wt. % | Wt. % | Wt. % |
| Pressure | Temperature | HFO- | HFO- | HFO- | HFO- | HFO- |
| (psia) | (° C.) | 1252zc | 1234yf | 1252zc | 1252zc | 1252zc |
| 16.4 | −28.5 | 58.7 | 41.3 | 0.1 to 99.9 | 25.5 to 99.9 | 40.8 to 78.9 |
| 24.1 | −19.1 | 56.1 | 43.9 | 0.1 to 99.9 | 21.4 to 99.9 | 37.4 to 77.5 |
| 34.8 | −9.3 | 53.8 | 46.2 | 0.1 to 99.9 | 17.2 to 99.9 | 34.0to 76.5 |
| 48.4 | 0.3 | 51.8 | 48.2 | 0.1 to 99.9 | 13.1 to 99.9 | 30.8 to 76.0 |
| 66.1 | 9.9 | 50.0 | 50.0 | 0.1 to 99.9 | 9.0 to 99.9 | 27.7 to 76.0 |
| 88.4 | 19.7 | 48.4 | 51.6 | 0.1 to 99.9 | 4.6 to 99.9 | 24.6 to 76.4 |
| 116.3 | 29.6 | 46.9 | 53.1 | 0.1 to 99.9 | 0.1 to 99.9 | 21.3 to 77.3 |
| 150.8 | 39.5 | 45.5 | 54.5 | 0.1 to 99.9 | 0.1 to 99.9 | 17.6 to 78.9 |
| 191.6 | 49.4 | 44.2 | 55.8 | 0.1 to 99.9 | 0.1 to 99.9 | 13.5 to 81.3 |
| 239.6 | 59.1 | 42.9 | 57.1 | 0.1 to 99.9 | 0.1 to 99.9 | 8.6 to 84.6 |
| 297.3 | 68.9 | 41.5 | 58.5 | 0.1 to 99.9 | 0.1 to 99.9 | 1.8 to 89.8 |
| 365.8 | 78.9 | 40.0 | 60.0 | 0.1 to 99.9 | 0.1 to 99.9 | 0.1 to 98.5 |

In view of the above data, temperature glide and relative volatility were applied to determine the azeotrope and azeotrope-like compositions.

The temperature glide and relative volatility of a mixture may be derived from thermodynamic measurements, such as those collected via PTx, subject to material balance and thermodynamic constraints. Several methods for deriving temperature glide from thermodynamic measurements are described in Sandler, S. I. (2006). Chapter 10: Vapor-Liquid Equilibrium in Mixtures. In Chemical, Biochemical, and Engineering Thermodynamics (4th ed., pp. 489-574) which includes constraining thermodynamic consistency through the fundamental Gibbs-Duhem relationship and resolving the vapor phase composition, from the measurements, through combined mass balance and equilibrium criteria (frequently referred to as the Rachford-Rice equation or algorithm). Through this derivation, the relationship between equilibrium compositions, temperatures, and pressures are established, permitting temperature glide and relative volatility to be evaluated.

For a given composition, the temperature glide, by definition, is the difference between the saturated vapor temperature and the saturated liquid temperature at a fixed pressure in thermodynamic equilibrium. Consequently, an azeotrope composition has a temperature glide of zero and an azeotrope-like composition has a temperature glide that is substantially close to zero. It has been identified that a temperature glide less than 0.5° C. is substantially close to zero and therefore compositions that satisfy such temperature glide are considered azeotrope-like. This is the broad azeotrope-like range.

The relative volatility, by definition, is the ratio of the vapor composition to the liquid composition of the most volatile component relative to the ratio of the vapor composition to the liquid composition of the less volatile component at a fixed pressure in thermodynamic equilibrium. Consequently, an azeotrope composition has a relative volatility of 1.0 and an azeotrope-like composition has a relative volatility that is substantially close to 1.0. It has been identified that a relative volatility of 1.1 is substantially close to 1.0 and therefore compositions that satisfy such relative volatility are considered azeotrope-like. This is the intermediate azeotrope-like range.

Additionally, it has been identified that a relative volatility of 1.05 is substantially close to 1.0 and therefore compositions that satisfy such relative volatility are considered azeotrope-like. This is the narrow azeotrope-like range.

### Example 9

### Residential Air-Conditioning System (Cooling)

Residential air-conditioning system used to supply cool air (about 12° C.) to buildings in the summer were tested using, as refrigerants, representative azeotrope and azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which are formulated as representative formulations of the azeotrope-like relative weight ranges set forth in Examples 1-9 above. Favorable heat transfer coefficient and coefficient of performance (COP) were observed when the system is operated at an evaporating temperature in the range of about 0° C. to about 10° C. and a condensing temperature in the range of about 40° C. to about 70° C.

TABLE 13
Residential Air-Conditioning System (Cooling)

| Refrigerant | | Cooling capacity | Cooling COP |
|---|---|---|---|
| R410A | | 100% | 100% |
| R1252zc/R32 | (8.1%/91.1%) | 107% | 102% |
| R1252zc/R134a | (59.5%/40.5%) | 47% | 108% |
| R1252zc/R152a | (70%/30%) | 48% | 109% |
| R1252zc/R1234yf | (46.9%/53.1%) | 43% | 108% |

Te = 10° C.,
Tc = 45° C.,
SH = 5° C.,
SC = 5° C.,
Isentropic efficiency = 70%,
displacement = equal

### Example 10

### Residential Air-Conditioning System (Heating)

Residential heat pump systems used to supply warm air (21° C.) to buildings in the winter are tested using, as refrigerants, azeotrope and azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which are formulated throughout the azeotrope-like relative weight ranges set forth in Examples 1-5 above respectively. Favorable heat transfer coefficient and COP are observed when the refrigerant evaporating temperature is in the range of about −30 to about 5° C. and the condensing temperature range is about 35 to about 50° C., optionally with POE and/or PVE lubricants.

### Example 11

### Commercial Air Conditioning (Chillers)

Commercial air-conditioning systems (chillers) used to supply chilled water (about 7° C.) to large buildings such as offices, hospitals, etc. were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf), each of which were formulated in accordance with the azeotrope-like relative weight ranges set forth in Examples 1-9 above. Favorable heat transfer coefficient was observed when the refrigerant evaporating temperature was in the range of about 0 to about 10° C. and the condensing temperature was in the range of about 40° C. to about 70° C., optionally with polyol ester (POE) and/or polyvinyl ether (PVE) lubricants.

TABLE 14
Commercial Air Conditioning (Chillers)

| Refrigerant | | Cooling capacity | Cooling COP |
|---|---|---|---|
| R32 | | 100% | 100% |
| R134a | | 100% | 100% |
| R1252zc/R32 | (8.1%/91.1%) | 98% | 100% |
| R1252zc/R134a | (59.5%/40.5%) | 105% | 100% |
| R1252zc/R152a | (70%/30%) | 108% | 101% |
| R1252zc/R1234yf | (46.9%/53.1%) | 96% | 99% |

Te = 4.5° C.,
Tc = 45° C.,
SH = 5° C.,
SC = 5° C.,
Isentropic efficiency = 70%,
displacement = equal

### Example 9

### Residential Air-to-Water Heat Pump Systems (Hydronic)

Residential air-to-water heat pump hydronic systems, such as mono-block heat pumps and chillers typically used to supply hot water (about 55° C.) to buildings for floor heating or similar applications in the winter were tested using, as refrigerants, representative azeotrope-like compositions of 1, 1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which were formulated in accordance with the azeotrope-like relative weight ranges set forth in Examples 1-9 above. Favorable thermodynamic performance was observed when the refrigerant evaporating temperature was in the range of about −30 to about 5° C. and the condensing temperature was in the range of about 50 to about 90° C.

TABLE 15
Residential Air-to-Water Heat pump Systems (Hydronic)

| Refrigerant | | Heating capacity | Heating COP |
|---|---|---|---|
| R32 | | 100% | 100% |
| R290 | | 100% | 100% |
| R1252zc/R32 | (8.1%/91.1%) | 98% | 99.5% |
| R1252zc/R134a | (59.5%/40.5%) | 76% | 102% |
| R1252zc/R152a | (70%/30%) | 80% | 104% |
| R1252zc/R1234yf | (46.9%/53.1%) | 68% | 100% |

Te = −10° C.,
Tc = 65° C.,
SH = 5° C.,
SC = 5° C.,
Isentropic efficiency = 70%,
displacement = equal

### Example 10

### Water/Brine-to-Air Heat Pump Systems

Mild climate water/brine to air heat pump systems, such as ground-source heat pumps using a secondary fluid in a liquid or two-phase state as a heat source for its evaporator and heating the indoor airflow through its condenser were tested using, as refrigerants, representative azeotrope-like compositions of 1, 1-difluoropropene (HFO-1252zc) and each of difluoromethane (HF-32), 1,1,12-tetrafluoroethane (HF-134a), 1,1-difluoroethane (HF-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was in the range of about −5° C. to about 5° C. and the condensing temperature range was about 30 to about 60° C., optionally with POE and/or PVE lubricants.

TABLE 16
Water/Brine-to-Air Heat Pump Systems

| Refrigerant | | Heating capacity | Heating COP |
|---|---|---|---|
| R32 | | 100% | 100% |
| R134a | | 100% | 100% |
| R1252zc/R32 | (8.1%/91.1%) | 99% | 100% |
| R1252zc/R134a | (59.5%/40.5%) | 106% | 100% |
| R1252zc/R152a | (70%/30%) | 108% | 100% |
| R1252zc/R1234yf | (46.9%/53.1%) | 98% | 100% |

Te = 0° C.,
Tc = 35° C.,
SH = 5° C.,
SC = 5° C.,
Isentropic efficiency = 70%,
displacement = equal

### Example 11

### Water/Brine to Water Heat Pumps

Mild climate water/brine to water heat pump systems, such as ground-source heat pumps using a secondary fluid in a liquid or two-phase state as a heat source for its evaporator and heating a secondary fluid, such as water, another refrigerant or brine, which is then used to heat the building were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was in the range of about −5° C. to about 5° C. and the condensing temperature range was about 35 to about 70° C., optionally with POE and/or PVE lubricants.

TABLE 17
Water/Brine to water heat pumps

| Refrigerant | | Heating capacity | Heating COP |
|---|---|---|---|
| R32 | | 100% | 100% |
| R290 | | 100% | 100% |
| R1252zc/R32 | (8.1%/91.1%) | 98% | 100% |
| R1252zc/R134a | (59.5%/40.5%) | 78% | 101% |
| R1252zc/R152a | (70%/30%) | 80% | 102% |
| R1252zc/R1234yf | (46.9%/53.1%) | 72% | 101% |

Te = 0° C.,
Tc = 45° C.,
SH = 5° C.,
SC = 5° C.,
Isentropic efficiency = 70%,
displacement = equal

### Example 12

### Domestic Hot Water Heat Pumps

Domestic hot water heat pumps using outdoor or indoor air as a heat source or use water as a heat source, such as sewage, to heat domestic hot water to be used in a building were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was about 10° C. and the condensing temperature range was about 55 to about 80° C., optionally with POE and/or PVE lubricants.

TABLE 18
Domestic hot water heat pumps

| Refrigerant | | Heating capacity | Heating COP |
|---|---|---|---|
| R32 | | 100% | 100% |
| R134a | | 100% | 100.0% |
| R1252zc/R32 | (8.1%/91.1%) | 98% | 99% |
| R1252zc/R134a | (59.5%/40.5%) | 104% | 100.1% |
| R1252zc/R152a | (70%/30%) | 108% | 101.3% |
| R1252zc/R1234yf | (46.9%/53.1%) | 94% | 98.8% |

Te = 10° C.,
Tc = 65° C.,
SH = 5° C.,
SC = 5° C.,
Isentropic efficiency = 70%,
displacement = equal

### Example 13

### Tumble Dryer and Other Small Appliance Heat Pumps

Tumble dryers and other small appliances, such as dishwashers and portable heat pumps which use outdoor or indoor air as a heat source, or use water as a heat source, such as sewage, to provide heat for small appliance applications were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was about 15° C. and the condensing temperature range was about 45 to about 80° C., optionally with POE and/or PVE lubricants.

TABLE 19
Tumble dryer and other small appliance heat pumps

| Refrigerant | | Heating capacity | Heating COP |
|---|---|---|---|
| R134a | | 100% | 100% |
| R1252zc/R32 | (8.1%/91.1%) | 236% | 94% |
| R1252zc/R134a | (59.5%/40.5%) | 103% | 100% |
| R1252zc/R152a | (70%/30%) | 106% | 101% |
| R1252zc/R1234yf | (46.9%/53.1%) | 94% | 99% |

Te = 15° C.,
Tc = 55° C.,
SH = 5° C.,
SC = 5° C.,
Isentropic efficiency = 70%,
displacement = equal

### Example 14

### Medium-Temperature Refrigeration System Performance

Medium temperature refrigeration systems used to chill food or beverages such as in a refrigerator and bottle cooler were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HF-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was in the range of about −12° C. to about 0° C. and the condensing temperature was in the range of about 20° C. to about 70° C., optionally with POE and/or PVE lubricants.

TABLE 20
Medium-temperature refrigeration system performance

| Refrigerant | | Cooling capacity | Cooling COP |
|---|---|---|---|
| R404A | | 100% | 100% |
| R1252zc/R32 | (8.1%/91.1%) | 158% | 105% |
| R1252zc/R134a | (59.5%/40.5%) | 64% | 109% |
| R1252zc/R152a | (70%/30%) | 66% | 110% |
| R1252zc/R1234yf | (46.9%/53.1%) | 59% | 108% |

Te = −7° C.,
Tc = 45° C.,
SH = 5° C.,
SC = 5° C.,
Isentropic efficiency = 70%,
displacement = equal

### Example 15

### Low-Temperature Refrigeration System Performance

Low-temperature refrigeration systems used to freeze food such as in an ice cream machine and a freezer were tested using, as refrigerants, representative azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which were formulated in accordance with the azeotrope-like relative weight ranges set forth in Examples 1-9 above. Favorable thermodynamic performance were observed when the refrigerant evaporating temperature was in the range of about −40° C. to about −12° C. and the condensing temperature was in the range of about 20 to about 70° C., optionally with POE and/or PVE lubricants.

TABLE 21
Low-temperature refrigeration system performance

| Refrigerant | | Cooling capacity | Cooling COP |
|---|---|---|---|
| R404A | | 100% | 100% |
| R1252zc/R32 | (8.1%/91.1%) | 166% | 107% |
| R1252zc/R134a | (59.5%/40.5%) | 62% | 109% |
| R1252zc/R152a | (70%/30%) | 65% | 111% |
| R1252zc/R1234yf | (46.9%/53.1%) | 57% | 108% |

Te = −25° C.,
Tc = 55° C.,
SH = 5° C.,
SC = 5° C.,
Isentropic efficiency = 70%,
displacement = equal

### Example 16

### Mobile Heat Pump Performance

Mobile heat pumps systems used to are used to supply cool air or warm air to the passenger compartment of an automobile are tested using, as refrigerants, azeotrope and azeotrope-like compositions of 1,1-difluoropropene (HFO-1252zc) and each of difluoromethane (HFC-32), 1,1,1,2-tetrafluoroethane (HFC-134a), 1,1-difluoroethane (HFC-152a), and 2,3,3,3-tetrafluoropropene (HFO-1234yf) which are formulated throughout the azeotrope-like relative weight ranges set forth in Examples 1-5 above respectively. Favorable thermodynamic performance is observed, optionally with POE, PVE, and/or polyalphaolefin (PAO) lubricants.

TABLE 22
Mobile Heat Pump Performance

| Refrigerant | | Heating capacity | Heating COP |
|---|---|---|---|
| R1234yf | | 100% | 100% |
| R1252zc/R32 | (8.1%/91.1%) | 262% | 99% |
| R1252zc/R134a | (59.5%/40.5%) | 110% | 103% |
| R1252zc/R152a | (70%/30%) | 113% | 103% |
| R1252zc/R1234yf | (46.9%/53.1%) | 101% | 102% |

Te = 0° C.,
Tc = 40° C.,
SH = 5° C.,
SC = 5° C.,
Isentropic efficiency = 70%,
displacement = equal

### Aspects

Aspect 1 is an azeotrope or azeotrope-like composition consisting essentially of effective amounts of 1,1-difluoropropene (HFO-1252zc) and difluoromethane (HFC-32).

Aspect 2 is the azeotrope or azeotrope-like composition of Aspect 1, consisting essentially of from about 0.01 wt. % to about 25.7 wt. % of 1,1-difluoropropene (HFO-1252zc) and from about 74.3 wt. % to about 99.9 wt. % of difluoromethane (HFC-32).

Aspect 3 is the azeotrope or azeotrope-like composition of Aspect 1, consisting essentially of from about 3.1 wt. % to about 14.2 wt. % of 1,1-difluoropropene (HFO-1252zc) and from about 85.8 wt. % to about 96.9 wt. % of difluoromethane (HFC-32).

Aspect 4 is the azeotrope or azeotrope-like composition of any one of Aspects 1 through 3, consisting essentially of from about 5.9 wt. % to about 11.5 wt. % of 1,1-difluoropropene (HFO-1252zc) and from about 88.5 wt. % to about 94.1 wt. % of difluoromethane (HFC-32).

Aspect 5 is the azeotrope or azeotrope-like composition of any one of Aspects 1 through 4, consisting essentially of about 8.6 wt. % of 1,1-difluoropropene (HFO-1252zc) and about 91.4 wt. % of difluoromethane (HFC-32).

Aspect 6 is the azeotrope or azeotrope-like composition of any one of Aspects 1 through 5, wherein the azeotrope or azeotrope-like composition has a boiling point of from about −28.5° C. to about 0.2° C., at a pressure of about 42.4 psia to about 118.5 psia.

Aspect 7 is an azeotrope or azeotrope-like composition consisting essentially of effective amounts of 1,1-difluoropropene (HFO-1252zc) and 1,1,1,2-tetrafluoroethane (HFC-134a).

Aspect 8 is the azeotrope or azeotrope-like composition of Aspect 7, consisting essentially of from about 0.1 wt. % to about 99.9 wt. % of 1,1-difluoropropene (HFO-1252zc) and from about 0.1 wt. % to about 99.9 wt. % of 1,1,1,2-tetrafluoroethane (HFC-134a).

Aspect 9 is the azeotrope or azeotrope-like composition of Aspect 7, consisting essentially of from about 15.0 wt. % to about 63.5 wt. % of 1, 1-difluoropropene (HFO-1252zc) and from about 36.5 wt. % to about 85.0 wt. % of 1, 1,1,2-tetrafluoroethane (HFC-134a).

Aspect 10 is the azeotrope or azeotrope-like composition of any one of Aspects 7 through 9, consisting essentially of from about 25.3 wt. % to about 49.7 wt. % of 1,1-difluoropropene (HFO-1252zc) and from about 50.3 wt. % to about 74.7 wt. % of 1,1,1,2-tetrafluoroethane (HFC-134a).

Aspect 11 is the azeotrope or azeotrope-like composition of any one of Aspects 7 through 10, consisting essentially of about 36.9 wt. % of 1,1-difluoropropene (HFO-1252zc) and about 63.1 wt. % of 1,1,1,2-tetrafluoroethane (HFC-134a).

Aspect 12 is the azeotrope or azeotrope-like composition of any one of Aspects 7 through 11, wherein the azeotrope or azeotrope-like composition has a boiling point of from about −29.4° C. to about 78.9° C., at a pressure of about 16.6 psia to about 403.5 psia.

Aspect 13 is an azeotrope or azeotrope-like composition consisting essentially of effective amounts of 1,1-difluoropropene (HFO-1252zc) and 1,1-difluoroethane (HFC-152a).

Aspect 14 is the azeotrope or azeotrope-like composition of Aspect 13, consisting essentially of from about 0.1 wt. % to about 99.9 wt. % of 1,1-difluoropropene (HFO-1252zc) and from about 0.1 wt. % to about 99.9 wt. % of 1,1-difluoroethane (HFC-152a).

Aspect 15 is the azeotrope or azeotrope-like composition of Aspect 13, consisting essentially of from about 38.0 wt. % to about 90.0 wt. % of 1,1-difluoropropene (HFO-1252zc) and from about 10.0 wt. % to about 62.0 wt. % of 1,1-difluoroethane (HFC-152a).

Aspect 16 is the azeotrope or azeotrope-like composition of any one of Aspects 13 through 15, consisting essentially of from about 51.2 wt. % to about 77.6 wt. % of 1,1-difluoropropene (HFO-1252zc) and from about 22.4 wt. % to about 48.8 wt. % of 1,1-difluoroethane (HFC-152a).

Aspect 17 is the azeotrope or azeotrope-like composition of any one of Aspects 13 through 16, consisting essentially of about 64.6 wt. % of 1,1-difluoropropene (HFO-1252zc) and about 35.4 wt. % of 1,1-difluoroethane (HFC-152a).

Aspect 18 is the azeotrope or azeotrope-like composition of any one of Aspects 13 through 17, wherein the azeotrope or azeotrope-like composition has a boiling point of from about −29.4° C. to about 78.9° C., at a pressure of about 16.0 psia to about 375.8 psia.

Aspect 19 is an azeotrope or azeotrope-like composition consisting essentially of effective amounts of 1,1-difluoropropene (HFO-1252zc) and 2,3,3,3-tetrafluoropropene (HFO-1234yf).

Aspect 20 is the azeotrope or azeotrope-like composition of Aspect 19, consisting essentially of from about 0.1 wt. % to about 99.9 wt. % of 1,1-difluoropropene (HFO-1252zc) and from about 0.1 wt. % to about 99.9 wt. % of 2,3,3,3-tetrafluoropropene (HFO-1234yf).

Aspect 21 is the azeotrope or azeotrope-like composition of any one of Aspects 19 and 20, consisting essentially of from about 0.1 wt. % to about 98.5 wt. % of 1,1-difluoropropene (HFO-1252zc) and from about 1.5 wt. % to about 99.9 wt. % of 2,3,3,3-tetrafluoropropene (HFO-1234yf).

Aspect 22 is the azeotrope or azeotrope-like composition of any one of Aspects 19 through 21, consisting essentially of about 40.0 wt. % of 1,1-difluoropropene (HFO-1252zc) and about 60.0 wt. % of 2,3,3,3-tetrafluoropropene (HFO-1234yf).

Aspect 23 is the azeotrope or azeotrope-like composition of any one of Aspects 19 through 22, wherein the azeotrope or azeotrope-like composition has a boiling point of from about −28.5° C. to about 78.9° C., at a pressure of about 16.4 psia to about 365.8 psia.

Aspect 24 is a heat transfer system comprising a refrigerant loop including a compressor, condenser, expansion valve and evaporator, and a refrigerant circulating within the refrigerant loop, the refrigerant comprising: an azeotrope or azeotrope-like composition consisting essentially of effective amounts of 1,1-difluoropropene (HFO-1252zc) and difluoromethane (HFC-32); an azeotrope or azeotrope-like composition consisting essentially of effective amounts of 1,1-difluoropropene (HFO-1252zc) and 1,1,1,2-tetrafluoroethane (HFC-134a); an azeotrope or azeotrope-like composition consisting essentially of effective amounts of 1,1-difluoropropene (HFO-1252zc) and 1,1-difluoroethane (HFC-152a); or an azeotrope or azeotrope-like composition consisting essentially of effective amounts of 1,1-difluoropropene (HFO-1252zc) and 2,3,3,3-tetrafluoropropene (HFO-1234yf).

Aspect 25 is the heat transfer system of Aspect 24, wherein the heat transfer system is selected from a residential air-conditioning/heat pump system, a commercial air-conditioning/heat pump system, a chiller system, a residential air-to-water heat pump hydronic system, a water/brine-to-air heat pump system, a water/brine-to-water heat pump system, a domestic hot water heat pump system, a tumble dryer or other small appliance heat pump system, a medium-temperature refrigeration system, a low-temperature refrigeration system, and a mobile air conditioning/heat pump system.

Aspect 26 is a method of operating a heat transfer system comprising a refrigerant loop including a compressor, condenser, expansion valve and evaporator, and a refrigerant circulating within the refrigerant loop, comprising: circulating, as a refrigerant in the heat transfer system: an azeotrope or azeotrope-like composition consisting essentially of effective amounts of 1,1-difluoropropene (HFO-1252zc) and difluoromethane (HFC-32); an azeotrope or azeotrope-like composition consisting essentially of effective amounts of 1,1-difluoropropene (HFO-1252zc) and 1,1,1,2-tetrafluoroethane (HFC-134a); an azeotrope or azeotrope-like composition consisting essentially of effective amounts of 1,1-difluoropropene (HFO-1252zc) and 1,1-difluoroethane (HFC-152a); or an azeotrope or azeotrope-like composition consisting essentially of effective amounts of 1,1-difluoropropene (HFO-1252zc) and 2,3,3,3-tetrafluoropropene (HFO-1234yf).

Aspect 27 is an azeotrope or azeotrope-like composition consisting essentially of effective amounts of 1,1-difluoropropene (HFO-1252zc) and one of difluoromethane (HFC-32), 1,1,1,2-tetrafluoroethane (HFC-134a), 1,1-difluoroethane (HFC-152a), or 2,3,3,3-tetrafluoropropene (HFO-1234yf).

What is claimed is:

1. An azeotrope or azeotrope-like composition consisting essentially of effective amounts of 1,1-difluoropropene (HFO-1252zc) and one of difluoromethane (HFC-32), 1,1,1,2-tetrafluoroethane (HFC-134a), 1,1-difluoroethane (HFC-152a), or 2,3,3,3-tetrafluoropropene (HFO-1234yf).

2. The azeotrope or azeotrope-like composition of claim 1, consisting essentially of from about 0.01 wt. % to about 25.7 wt. % of 1,1-difluoropropene (HFO-1252zc) and from about 74.3 wt. % to about 99.9 wt. % of difluoromethane (HFC-32).

3. The azeotrope or azeotrope-like composition of claim 1, consisting essentially of from about 3.1 wt. % to about 14.2 wt. % of 1,1-difluoropropene (HFO-1252zc) and from about 85.8 wt. % to about 96.9 wt. % of difluoromethane (HFC-32).

4. The azeotrope or azeotrope-like composition of claim 1, consisting essentially of from about 5.9 wt. % to about 11.5 wt. % of 1,1-difluoropropene (HFO-1252zc) and from about 88.5 wt. % to about 94.1 wt. % of difluoromethane (HFC-32).

5. The azeotrope or azeotrope-like composition of claim 1, consisting essentially of from about 0.1 wt. % to about 99.9 wt. % of 1,1-difluoropropene (HFO-1252zc) and from about 0.1 wt. % to about 99.9 wt. % of 1,1,1,2-tetrafluoroethane (HFC-134a).

6. The azeotrope or azeotrope-like composition of claim 1, consisting essentially of from about 15.0 wt. % to about 63.5 wt. % of 1,1-difluoropropene (HFO-1252zc) and from about 36.5 wt. % to about 85.0 wt. % of 1,1,1,2-tetrafluoroethane (HFC-134a).

7. The azeotrope or azeotrope-like composition of claim 1, consisting essentially of from about 25.3 wt. % to about 49.7 wt. % of 1,1-difluoropropene (HFO-1252zc) and from about 50.3 wt. % to about 74.7 wt. % of 1,1,1,2-tetrafluoroethane (HFC-134a).

8. The azeotrope or azeotrope-like composition of claim 1, consisting essentially of from about 0.1 wt. % to about 99.9 wt. % of 1,1-difluoropropene (HFO-1252zc) and from about 0.1 wt. % to about 99.9 wt. % of 1,1-difluoroethane (HFC-152a).

9. The azeotrope or azeotrope-like composition of claim 1, consisting essentially of from about 38.0 wt. % to about 90.0 wt. % of 1,1-difluoropropene (HFO-1252zc) and from about 10.0 wt. % to about 62.0 wt. % of 1,1-difluoroethane (HFC-152a).

10. The azeotrope or azeotrope-like composition of claim 1, consisting essentially of from about 51.2 wt. % to about 77.6 wt. % of 1,1-difluoropropene (HFO-1252zc) and from about 22.4 wt. % to about 48.8 wt. % of 1,1-difluoroethane (HFC-152a).

11. The azeotrope or azeotrope-like composition of claim 1, consisting essentially of from about 0.1 wt. % to about 99.9 wt. % of 1,1-difluoropropene (HFO-1252zc) and from about 0.1 wt. % to about 99.9 wt. % of 2,3,3,3-tetrafluoropropene (HFO-1234yf).

12. The azeotrope or azeotrope-like composition of claim 1, consisting essentially of from about 0.1 wt. % to about 98.5 wt. % of 1,1-difluoropropene (HFO-1252zc) and from about 1.5 wt. % to about 99.9 wt. % of 2,3,3,3-tetrafluoropropene (HFO-1234yf).

13. The azeotrope or azeotrope-like composition of claim 1, consisting essentially of about 40.0 wt. % of 1,1-difluoropropene (HFO-1252zc) and about 60.0 wt. % of 2,3,3,3-tetrafluoropropene (HFO-1234yf).

14. A heat transfer system comprising a refrigerant loop including a compressor, condenser, expansion valve and evaporator, and a refrigerant circulating within the refrigerant loop, the refrigerant comprising: an azeotrope or azeotrope-like composition consisting essentially of effective amounts of 1,1-difluoropropene (HFO-1252zc) and difluoromethane (HFC-32); an azeotrope or azeotrope-like composition consisting essentially of effective amounts of 1,1-difluoropropene (HFO-1252zc) and 1,1,1,2-tetrafluoroethane (HFC-134a); an azeotrope or azeotrope-like composition consisting essentially of effective amounts of 1,1-difluoropropene (HFO-1252zc) and 1,1-difluoroethane (HFC-152a); or an azeotrope or azeotrope-like composition consisting essentially of effective amounts of 1,1-difluoropropene (HFO-1252zc) and 2,3,3,3-tetrafluoropropene (HFO-1234yf).

15. The heat transfer system of claim 14, wherein the heat transfer system is selected from a residential air-conditioning/heat pump system, a commercial air-conditioning/heat pump system, a chiller system, a residential air-to-water heat pump hydronic system, a water/brine-to-air heat pump system, a water/brine-to-water heat pump system, a domestic hot water heat pump system, a tumble dryer or other small appliance heat pump system, a medium-temperature refrigeration system, a low-temperature refrigeration system, and a mobile air conditioning/heat pump system.

16. A method of operating a heat transfer system comprising a refrigerant loop including a compressor, condenser, expansion valve and evaporator, and a refrigerant circulating within the refrigerant loop, comprising: circulating, as a refrigerant in the heat transfer system: an azeotrope or azeotrope-like composition consisting essentially of effective amounts of 1,1-difluoropropene (HFO-1252zc) and difluoromethane (HFC-32); an azeotrope or azeotrope-like composition consisting essentially of effective amounts of 1,1-difluoropropene (HFO-1252zc) and 1,1,1,2-tetrafluoroethane (HFC-134a); an azeotrope or azeotrope-like composition consisting essentially of effective amounts of 1,1-difluoropropene (HFO-1252zc) and 1,1-difluoroethane (HFC-152a); or an azeotrope or azeotrope-like composition consisting essentially of effective amounts of 1,1-difluoropropene (HFO-1252zc) and 2,3,3,3-tetrafluoropropene (HFO-1234yf).
